(19) United States
(12) Patent Application Publication
(10) Pub. No.: US 2026/0236259 A1
(43) Pub. Date: Aug. 13, 2026

(54) METHOD AND APPARATUS FOR INSERTING SYNCHRONIZATION PRIMITIVE, AND RELATED DEVICE

(71) Applicant: Huawei Technologies Co., Ltd., Shenzhen (CN)

(72) Inventors: Shuaijiang Li, Beijing (CN); Xinghui Tian, Hangzhou (CN); Xiaoxin Xu, Hangzhou (CN); Jiacheng Zhao, Beijing (CN); Huimin Cui, Beijing (CN)

(21) Appl. No.: 19/368,086

(22) Filed: Oct. 24, 2025

Related U.S. Application Data
(63) Continuation of application No. PCT/CN2024/089356, filed on Apr. 23, 2024.

(30) Foreign Application Priority Data
Apr. 25, 2023 (CN) 202310474325.2

(51) Int. Cl. G06F 9/30; G06F 9/455

(52) U.S. Cl. CPC G06F 9/30076; G06F 9/455

(57) ABSTRACT

This application provides a method and an apparatus for inserting a synchronization primitive, and a computing device. The method includes: The computing device obtains a plurality of instruction pairs in a program, then inserts a corresponding virtual synchronization primitive including a virtual identity into each instruction pair, and finally determines, based on the virtual synchronization primitive corresponding to each instruction pair, a synchronization primitive corresponding to each instruction pair. The synchronization primitive includes an event identity. A source instruction and a destination instruction in the instruction pair are executed by two different execution units. A quantity of event identities corresponding to any two execution units is fixed and is less than a quantity of virtual identities corresponding to the two execution units.

### CROSS-REFERENCE TO RELATED APPLICATIONS

This application is a continuation of International Application No. PCT/CN2024/089356, filed on Apr. 23, 2024, which claims priority to Chinese Patent Application No. 202310474325.2, filed on Apr. 25, 2023. The disclosures of the aforementioned applications are hereby incorporated by reference in their entireties.

### TECHNICAL FIELD

This application relates to the field of computer technologies, and in particular, to a method and an apparatus for inserting a synchronization primitive, and a related device.

### BACKGROUND

With rapid development of artificial intelligence (AI) represented by deep learning, to meet increasing computing power requirements of various AI applications, various heterogeneous accelerator cards used to accelerate AI computing emerge, for example, a graphics processing unit (GPU) and a tensor processing unit (TPU).

In terms of hardware design, the heterogeneous accelerator card usually uses a combination of a plurality of functional units. Different functional units perform their functions to form different independent execution pipelines, and cooperate with each other to implement different instruction functions under unified scheduling of system software and hardware, optimizing computing efficiency, and balancing performance and completeness.

Different from a conventional central processing unit (CPU), the heterogeneous accelerator card does not need complex control and instruction scheduling logic to ensure dependency between instructions; instead, a synchronization primitive needs to be inserted into a program to ensure the dependency between the instructions. Therefore, how to add a synchronization primitive to a program to ensure dependency between instructions is an urgent problem to be resolved.

### SUMMARY

This application provides a method and an apparatus for inserting a synchronization primitive, and a related device, to automatically insert the synchronization primitive into a program, so as to ensure dependency between instructions that have a dependency relationship, improve efficiency of inserting the synchronization primitive into the program, and reduce programming difficulty for a programmer.

According to a first aspect, this application provides a method for inserting a synchronization primitive. The method includes: A computing device obtains a plurality of instruction pairs in a program, then inserts a corresponding virtual synchronization primitive including a virtual identity (ID) into each instruction pair, for example, inserts a first virtual synchronization primitive including a first virtual ID into a first instruction pair, and finally determines, based on the virtual synchronization primitive corresponding to each instruction pair, a synchronization primitive corresponding to each instruction pair, for example, determines, based on the first virtual synchronization primitive, a first synchronization primitive corresponding to the first instruction pair. The synchronization primitive includes an event ID. For example, the first synchronization primitive includes a first event ID. Each instruction pair includes a source instruction and a destination instruction that have a dependency relationship, and the source instruction and the destination instruction are executed by two different execution units. A quantity of event IDs corresponding to any two execution units is a preset fixed value, and a quantity of event IDs corresponding to the two execution units is less than a quantity of virtual IDs corresponding to the two execution units. For example, a quantity of event IDs corresponding to two execution units that execute the first instruction pair is a preset fixed value, and a quantity of virtual IDs corresponding to the two execution units that execute the first instruction pair is greater than the quantity of event IDs.

The instruction pairs in the program are determined, corresponding virtual synchronization primitives are respectively inserted into the instruction pairs, and then the synchronization primitive corresponding to each virtual synchronization primitive is determined based on the virtual synchronization primitive, so that the synchronization primitive can be automatically inserted into the program, to ensure dependency between instructions that have a dependency relationship, improve efficiency of inserting the synchronization primitive into the program, and reduce programming difficulty for a programmer.

It should be understood that the event ID indicates a flag bit in an accelerator card. A quantity of flag bits corresponding to the any two execution units is limited and fixed. For example, there are only N flag bits between the two execution units that execute the first instruction pair. In this case, a value of the event ID ranges from 1 to N. However, a quantity of determined instruction pairs in instructions executed by the any two execution units is usually greater than N. If the synchronization primitive is inserted into the instruction pair, the event ID is simply used cyclically. For example, if the quantity of event IDs is 3, synchronization primitives corresponding to the first three instruction pairs use one event ID, and synchronization primitives corresponding to the following three instruction pairs use the remaining two event IDs. In this way, the following situation may occur on two synchronization primitives (for example, a synchronization primitive A and a synchronization primitive B) that use a same event ID: A set instruction of the synchronization primitive A sets a flag bit corresponding to the event ID, but the program has not executed a wait instruction of the synchronization primitive A, that is, the flag bit corresponding to the event ID is still occupied. In this case, the program may execute a set instruction of the synchronization primitive B, and the set instruction of the synchronization primitive B needs to set the flag bit. This causes a program execution error. Therefore, the virtual synchronization primitive is inserted first, and then an event ID corresponding to a virtual ID in the virtual synchronization primitive is determined, to ensure that a same flag bit is not occupied by two synchronization primitives at the same time during program execution. This ensures smooth program execution.

In a possible implementation, the virtual synchronization primitive includes a virtual set instruction and a virtual wait instruction. The synchronization primitive includes a set instruction and a wait instruction. The synchronization primitive is obtained by replacing the virtual ID in the virtual synchronization primitive with the event ID.

For example, the first virtual synchronization primitive includes a first virtual set instruction and a first virtual wait instruction, and the first virtual set instruction and the first virtual wait instruction each include the first virtual ID.

The first synchronization primitive includes a first set instruction and a first wait instruction. The first set instruction and the first wait instruction each include the first event ID. The first synchronization primitive is obtained by replacing the first virtual ID in the first virtual synchronization primitive with the first event ID. The first set instruction is executed after a source instruction in the first instruction pair is executed. A flag bit corresponding to the first event ID is set. The first wait instruction is used to determine, when being executed, whether the flag bit corresponding to the first event ID is set. When the flag bit corresponding to the first event ID is set, a destination instruction in the first instruction pair is executed.

In a possible implementation, the determining, based on the first virtual synchronization primitive, a first synchronization primitive corresponding to the first instruction pair includes: selecting the first event ID from the event IDs corresponding to the two execution units that execute the first instruction pair; determining a second synchronization primitive that uses the first event ID last time; and when a happen-before relationship exists between the second synchronization primitive and the first virtual synchronization primitive, if it is determined that the first event ID can be assigned to the first virtual synchronization primitive, replacing the first virtual ID in the first virtual synchronization primitive with the first event ID, to obtain the first synchronization primitive.

The second synchronization primitive is obtained by replacing a virtual ID in a corresponding second virtual synchronization primitive with the first event ID. A second set instruction in the second synchronization primitive and the first set instruction in the first synchronization primitive are executed by a same execution unit. A second wait instruction in the second synchronization primitive and the first wait instruction in the first synchronization primitive are executed by a same execution unit.

After the first event ID is assigned to a second virtual primitive, and the virtual ID in the second virtual synchronization primitive is replaced with the first event ID to obtain the second synchronization primitive, when it is determined to reassign the first event ID to the first virtual synchronization primitive, and replace the first virtual ID with the first event ID to obtain the first synchronization primitive, it needs to be ensured that the happen-before relationship exists between the second virtual synchronization primitive and the first virtual synchronization primitive. In this way, in an actual execution process of the program, before the first synchronization primitive is executed, the second synchronization primitive has been finished, so that the second synchronization primitive no longer occupies the first event ID. This can avoid a case in which the program cannot run normally because two synchronization primitives simultaneously use a flag bit corresponding to a same event ID.

In a possible implementation, the determining, based on the first virtual synchronization primitive, a first synchronization primitive corresponding to the first instruction pair includes: selecting the first event ID from the event IDs corresponding to the two execution units that execute the first instruction pair; determining a second synchronization primitive that uses the first event ID last time; and when an unreachable relationship exists between the second synchronization primitive and the first virtual synchronization primitive, if it is determined that the first event ID can be assigned to the first virtual synchronization primitive, replacing the first virtual ID in the first virtual synchronization primitive with the first event ID, to obtain the first synchronization primitive.

The second synchronization primitive is obtained by replacing a virtual ID in a corresponding second virtual synchronization primitive with the first event ID. A second set instruction in the second synchronization primitive and the first set instruction in the first synchronization primitive are executed by a same execution unit. A second wait instruction in the second synchronization primitive and the first wait instruction in the first synchronization primitive are executed by a same execution unit.

After the first event ID is assigned to a second virtual primitive, and the virtual ID in the second virtual synchronization primitive is replaced with the first event ID to obtain the second synchronization primitive, when it is determined to reassign the first event ID to the first virtual synchronization primitive, and replace the first virtual ID with the first event ID to obtain the first synchronization primitive, it needs to be ensured that the unreachable relationship exists between the second virtual synchronization primitive and the first virtual synchronization primitive, or the unreachable relationship exists between the second synchronization primitive and the first virtual synchronization primitive. In this way, in an actual execution process of the program, before a path of the first synchronization primitive is executed, the second synchronization primitive is not executed, so that the second synchronization primitive does not occupy the first event ID. This can avoid a case in which the program cannot run normally because two synchronization primitives simultaneously use a flag bit corresponding to a same event ID.

In a possible implementation, the determining, based on the first virtual synchronization primitive, a first synchronization primitive corresponding to the first instruction pair includes: selecting the first event ID from the event IDs corresponding to the two execution units that execute the first instruction pair; determining a second synchronization primitive that uses the first event ID last time; and when no happen-before relationship or unreachable relationship exists between the second synchronization primitive and the first virtual synchronization primitive, after a third virtual synchronization primitive is inserted between the second synchronization primitive and the first virtual synchronization primitive, replacing the first virtual ID in the first virtual synchronization primitive with the first event ID, to obtain the first synchronization primitive.

The third virtual synchronization primitive includes a third virtual set instruction and a third virtual wait instruction. The third virtual set instruction is inserted after the second wait instruction in the second synchronization primitive. The third virtual wait instruction is inserted before a first virtual set instruction in the first virtual synchronization primitive.

After the first event ID is assigned to a second virtual primitive, and a virtual ID in a second virtual synchronization primitive is replaced with the first event ID to obtain the second synchronization primitive, when it is determined to reassign the first event ID to the first virtual synchronization primitive, and replace the first virtual ID with the first event ID to obtain the first synchronization primitive, if no happen-before relationship or unreachable relationship exists between the second synchronization primitive and the first virtual synchronization primitive, the third virtual synchronization primitive is inserted, so that the happen-before relationship exists between the second synchronization primitive and the first virtual synchronization primitive. In this way, in an actual execution process of the program, before the first synchronization primitive is executed, the second synchronization primitive has been finished, so that the second synchronization primitive no longer occupies the first event ID. This can avoid a case in which the program cannot run normally because two synchronization primitives simultaneously use a flag bit corresponding to a same event ID.

In a possible implementation, before the determining, based on the first virtual synchronization primitive, a first synchronization primitive corresponding to the first instruction pair, the method further includes merging virtual synchronization primitives: for virtual synchronization primitives executed by the two execution units that execute the first instruction pair, obtaining a currently active virtual ID at a first program point; and when a quantity of active virtual IDs is greater than N, merging virtual synchronization primitives to which the active virtual IDs belong, where N is a quantity of event IDs between two execution units, the active virtual ID is a virtual ID in a virtual synchronization primitive corresponding to an unfinished instruction pair when the program is executed to the first program point, virtual set instructions in the virtual synchronization primitives to which the active virtual IDs belong are executed by a same execution unit, and virtual wait instructions in the virtual synchronization primitives to which the active virtual IDs belong are executed by a same execution unit.

Virtual synchronization primitives corresponding to currently active virtual IDs are merged, to ensure that a quantity of active virtual IDs is less than or equal to a quantity of event IDs at any program point of the program when the program is statically analyzed.

In a possible implementation, the merging virtual synchronization primitives to which the active virtual IDs belong includes: if a source instruction and a destination instruction in an instruction pair corresponding to a fourth virtual synchronization primitive that uses a second virtual ID are cross-iteration instructions, a source instruction and a destination instruction in an instruction pair corresponding to a fifth virtual synchronization primitive that uses a third virtual ID are cross-iteration instructions, a fourth virtual wait instruction in the fourth virtual synchronization primitive dominates a fifth virtual wait instruction in the fifth virtual synchronization primitive, and a fifth virtual set instruction in the fifth virtual synchronization primitive post-dominates a fourth virtual set instruction in the fourth virtual synchronization primitive, deleting the fourth virtual set instruction in the fourth virtual synchronization primitive and the fifth virtual wait instruction in the fifth virtual synchronization primitive, and replacing the third virtual ID in the fifth virtual set instruction in the fifth virtual synchronization primitive with the second virtual ID in the fourth synchronization primitive. The second virtual ID and the third virtual ID belong to the active virtual IDs.

Because the fourth virtual wait instruction dominates the fifth virtual wait instruction, and the fifth virtual set instruction post-dominates the fourth virtual set instruction, when the program is executed, an execution sequence is the fourth virtual set instruction, the fifth virtual set instruction, the fourth virtual wait instruction, and the fifth virtual wait instruction. In view of this, only the fifth virtual set instruction needs to be retained, to ensure that the source instruction in the instruction pair corresponding to the fourth virtual synchronization primitive has been executed when the fourth virtual wait instruction is executed; and only the fourth virtual wait instruction needs to be retained, to ensure that the source instruction in the instruction pair corresponding to the fifth virtual synchronization primitive and the fifth virtual set instruction have been executed when the destination instruction in the instruction pair corresponding to the fifth virtual synchronization primitive is executed.

In a possible implementation, if neither the source instruction nor the destination instruction in the instruction pair corresponding to each of the fourth virtual synchronization primitive and the fifth virtual synchronization primitive is a cross-iteration instruction, a target virtual set instruction and a target virtual wait instruction are retained, virtual synchronization primitives that use the second virtual ID and the third virtual ID other than the target virtual set instruction and the target virtual wait instruction are deleted, a virtual ID in the target virtual set instruction and the target virtual wait instruction is replaced with the second virtual ID. The target virtual set instruction is a 2^{nd} virtual set instruction that uses the second virtual ID or the third virtual ID and that is encountered in a process of traversing the program. The target virtual wait instruction is a 1^{st} virtual wait instruction that uses the second virtual ID or the third virtual ID and that is encountered in the process of traversing the program.

In a possible implementation, before the determining, based on the first virtual synchronization primitive, a first synchronization primitive corresponding to the first instruction pair, the method further includes: performing, based on a dominance relationship and/or a post-dominance relationship between virtual synchronization primitives corresponding to different instruction pairs, redundancy removal on the virtual synchronization primitives corresponding to the instruction pairs, where source instructions in the different instruction pairs are executed by a same execution unit, and destination instructions in the different instruction pairs are executed by a same execution unit.

Redundancy removal is performed on two virtual synchronization primitives that meet the dominance relationship and/or the post-dominance relationship, so that a quantity of synchronization primitives in the program can be reduced, introduction of excessive synchronization primitives can be avoided, and program performance can be improved.

Optionally, when redundancy removal is performed on the virtual synchronization primitive, if a second source instruction in a second instruction pair corresponding to an eighth virtual synchronization primitive whose virtual ID is a is the same as a third source instruction in a third instruction pair corresponding to a ninth virtual synchronization primitive whose virtual ID is b, and if a virtual wait instruction in the eighth virtual synchronization primitive dominates a virtual wait instruction in the ninth virtual synchronization primitive, the ninth virtual synchronization primitive whose virtual ID is b is deleted. That the virtual wait instruction in the eighth virtual synchronization primitive dominates the virtual wait instruction in the ninth virtual synchronization primitive means that virtual wait instructions whose virtual IDs are a exist on paths from the source instruction in the third instruction pair to all virtual wait instructions whose virtual IDs are b.

An execution sequence of the instruction pair and the virtual synchronization primitive that meet the foregoing relationship is as follows: the second/third source instruction, a virtual set instruction in the eighth virtual synchronization primitive, a virtual set instruction in the ninth virtual synchronization primitive, the virtual wait instruction in the eighth virtual synchronization primitive, a second destination instruction in the second instruction pair, the virtual wait instruction in the ninth virtual synchronization primitive, and a third destination instruction in the third instruction pair. In this case, when the virtual wait instruction in the ninth virtual synchronization primitive and the third destination instruction in the third instruction pair are executed, the virtual wait instruction in the eighth virtual synchronization primitive is definitely finished, and the second source instruction/third source instruction is definitely finished. In view of this, before the third destination instruction is executed, the ninth virtual synchronization primitive may be deleted without a need to execute the virtual set instruction and the virtual wait instruction in the ninth virtual synchronization primitive.

Optionally, if a destination instruction in a second instruction pair corresponding to an eighth virtual synchronization primitive whose virtual ID is a is the same as a destination instruction in a third instruction pair corresponding to a ninth virtual synchronization primitive whose virtual ID is b, and if a virtual set instruction in the eighth virtual synchronization primitive post-dominates a virtual set instruction in the ninth virtual synchronization primitive, the ninth virtual synchronization primitive whose virtual ID is b is deleted. That the virtual set instruction in the eighth virtual synchronization primitive post-dominates the virtual set instruction in the ninth virtual synchronization primitive means that virtual set instructions whose virtual IDs are a exist on paths from a source instruction in the third instruction pair to the destination instruction in the third instruction.

An execution sequence of the instruction pair and the virtual synchronization primitive that meet the foregoing relationship is as follows: a third source instruction, the virtual set instruction in the ninth virtual synchronization primitive, a second source instruction, the virtual set instruction in the eighth virtual synchronization primitive, a virtual wait instruction in the ninth virtual synchronization primitive, a virtual wait instruction in the eighth virtual synchronization primitive, and a second/third destination instruction. When the virtual wait instruction in the eighth virtual synchronization primitive and the third destination instruction are executed, the virtual set instruction in the eighth virtual synchronization primitive and the second source instruction are definitely finished, and the third source instruction is definitely finished. In view of this, after the third source instruction is executed, a virtual synchronization primitive corresponding to the third instruction pair may be deleted without a need to execute the virtual set instruction and the virtual wait instruction in the ninth virtual synchronization primitive.

Optionally, if a source instruction and a destination instruction in a second instruction pair corresponding to an eighth virtual synchronization primitive whose virtual ID is a are respectively different from a source instruction and a destination instruction in a third instruction pair corresponding to a ninth virtual synchronization primitive whose virtual ID is b, and if a virtual set instruction in the eighth virtual synchronization primitive post-dominates a virtual set instruction in the ninth virtual synchronization primitive, and a virtual wait instruction in the eighth virtual synchronization primitive dominates a virtual wait instruction in the ninth virtual synchronization primitive, the ninth virtual synchronization primitive whose virtual ID is b is deleted.

In a possible implementation, the inserting a first virtual synchronization primitive into a first instruction pair includes: inserting a first virtual set instruction after a first source instruction in the first instruction pair, and inserting a first virtual wait instruction before a first destination instruction in the first instruction pair.

Optionally, when neither the first source instruction nor the first destination instruction in the first instruction pair is in a loop, a first virtual set instruction is inserted between the first source instruction and an instruction next to the first source instruction, and a first virtual wait instruction is inserted between the first destination instruction and an instruction previous to the first destination instruction.

Optionally, when the first source instruction is in a loop L0 and the first destination instruction is not in an outermost loop L to which the first source instruction belongs, a first virtual set instruction corresponding to the first source instruction is inserted into an exit block of the outermost loop L.

In the foregoing case, the first virtual set instruction is inserted into the exit block of the outermost loop L, to avoid a case in which a same flag bit is set for a plurality of consecutive times in an execution process of a loop.

Optionally, when the first destination instruction is in a loop C0 and the first source instruction is not in an outermost loop C to which the first destination instruction belongs, a first virtual wait instruction corresponding to the first destination instruction is inserted into a preheader of the outermost loop C.

In the foregoing case, the loop is executed for a plurality of times. When the first virtual wait instruction is executed during a 1^{st} execution loop, the wait instruction has been reset. When the first virtual wait instruction is executed again, because there is no corresponding virtual set instruction in the loop, the program is blocked and cannot continue to be executed. The foregoing problem can be avoided by inserting the first virtual wait instruction into the preheader of the outermost loop C.

The preheader is a precursor of a loop header of a loop in a control flow graph, and is located outside the loop. In a standardized control flow graph, a loop header of one loop has only one precursor, namely, a preheader, and the preheader has only one successor, namely, a loop header. The exit block is a basic block (BB) corresponding to the preheader and is located after an exiting block of the loop. All precursors of the exit block are in the loop.

In a possible implementation, after a corresponding first virtual synchronization primitive is inserted into a first instruction pair, additional virtual synchronization primitives need to be inserted into some instruction pairs. Optionally, if the first instruction pair includes instructions that have a cross-iteration dependency relationship, a first virtual wait instruction is inserted after the first virtual set instruction, and a first virtual set instruction is inserted before the first virtual wait instruction. For example, a first virtual set instruction is inserted into a preheader of a loop to which the first instruction pair belongs, and a first virtual wait instruction is inserted into an exit block of the loop to which the first instruction pair belongs.

Optionally, if the first source instruction and the first destination instruction in the first instruction pair are unreachable to each other, a first virtual wait instruction is inserted before the first virtual set instruction, and a first virtual set instruction is inserted after the first virtual wait instruction. For example, a first virtual wait instruction is inserted before a first virtual set instruction of a basic block to which the first virtual set instruction belongs, and a first virtual set instruction is inserted after a first virtual wait instruction of the basic block to which the first virtual wait instruction belongs.

For an instruction pair in which a source instruction and a destination instruction are cross-iteration instructions, or an instruction pair in which a source instruction and a destination instruction are unreachable to each other, a corresponding additional virtual synchronization primitive is inserted to ensure that a corresponding virtual wait instruction is executed each time after a virtual set instruction is executed, and a corresponding virtual set instruction is executed each time before a virtual wait instruction is executed, so as to ensure that the program can be executed normally.

In a possible implementation, further improving a control flow graph of the program before a first virtual synchronization primitive is inserted into a first instruction pair includes: when a first loop does not have a preheader and an exit block, adding the preheader and the exit block to the first loop, where the first loop is any loop in the program.

In a possible implementation, further improving a control flow graph of the program before a first virtual synchronization primitive is inserted into a first instruction pair includes: when a last instruction in a first basic block is an indirect jump instruction, a quantity of successors of the first basic block is greater than 1, a second basic block is a successor of the first basic block, and the second basic block post-dominates the first basic block, adding a third basic block between the first basic block and the second basic block, replacing, with the third basic block, the second basic block in the successors of the first basic block in a control flow graph corresponding to the program, and replacing a first basic block in input basic blocks of a PHI node of the second basic block with the third basic block.

The control flow graph of the program is improved, so that the foregoing operation of inserting an additional virtual synchronization primitive can be implemented.

In a possible implementation, after a first virtual synchronization primitive is inserted into a first instruction pair, the virtual synchronization primitive needs to be further improved, and an additional virtual set instruction or virtual wait instruction needs to be inserted into the program. This includes:
traversing a basic block corresponding to the program; and for a currently traversed basic block, for example, a fourth basic block, when the fourth basic block has a plurality of precursors, inserting a virtual set instruction or a virtual wait instruction into the plurality of precursors based on sequence lengths of the plurality of precursors, so that a virtual set instruction and a virtual wait instruction on any execution path of the program are in pairs, where a sequence length corresponding to one precursor is a sum of a quantity of virtual set instructions and a quantity of virtual wait instructions that are in the precursor and for which a source pipeline and a destination pipeline are the same; and
if the fourth basic block has a plurality of precursors, first obtaining an entry state of the fourth basic block and the sequence lengths of the precursors; then, for any one of the precursors, for example, a fifth basic block, if a remainder of a modulo-2 operation of a sequence length of the fifth basic block is equal to a remainder of a modulo-2 operation of the entry state of the fourth basic block, determining that no virtual set instruction or virtual wait instruction needs to be inserted into the fifth basic block, where a sequence length of a precursor is a quantity of virtual set instructions and virtual wait instructions in the precursor that are executed by a first pipeline pair; to be specific, when a virtual synchronization primitive corresponding to the first pipeline pair is improved, the sequence length of the precursor is a quantity of virtual set primitives and virtual wait instructions whose source pipeline is a pipeline 1 and destination pipeline is a pipeline 2; and an entry state of a current basic block is a value with a maximum sequence length among all precursors of the current basic block; or
if a remainder of a modulo-2 operation of a sequence length of the fifth basic block is not equal to a remainder of a modulo-2 operation of the entry state of the fourth basic block, determining that a virtual set instruction or a virtual wait instruction needs to be inserted into the fifth basic block, where specifically, if the entry state of the fourth basic block cannot be exactly divided by 2, a virtual set instruction needs to be inserted into the fifth basic block, and a virtual ID in the virtual set instruction is the same as a virtual ID in a first virtual wait instruction in the fourth basic block; or if the entry state of the fourth basic block can be exactly divided by 2, a virtual wait instruction needs to be inserted into the fifth basic block, and a virtual ID in the virtual wait instruction is the same as a virtual ID in a virtual set instruction before the virtual wait instruction.

The virtual synchronization primitive is improved, and the additional virtual set instruction or virtual wait instruction is inserted into the program, to ensure that virtual set instructions and virtual wait instructions on all execution paths are in pairs when the program is executed, thereby ensuring that the program can be executed normally.

In a possible implementation, the method further includes: performing read-after-write analysis, write-after-read analysis, and write-after-write analysis on the program, to determine a plurality of instruction pairs that have a dependency relationship in the program.

According to a second aspect, an embodiment of this application provides an apparatus for inserting a synchronization primitive, including:
an obtaining module, configured to obtain a plurality of instruction pairs in a program, where each instruction pair includes a source instruction and a destination instruction that have a dependency relationship, and the source instruction and the destination instruction in each instruction pair are executed by two different execution units;
an insertion module, configured to insert a first virtual synchronization primitive into a first instruction pair, where the first virtual synchronization primitive includes a first virtual identity ID, and the first instruction pair is any one of the plurality of instruction pairs; and
a processing module, configured to determine, based on the first virtual synchronization primitive, a first synchronization primitive corresponding to the first instruction pair, where the first synchronization primitive includes a first event ID, a quantity of event IDs corresponding to two execution units that execute the first instruction pair is a preset fixed value, and a quantity of virtual IDs corresponding to the two execution units that execute the first instruction pair is greater than the quantity of the event IDs.

The instruction pairs in the program are obtained, corresponding virtual synchronization primitives are respectively inserted into the instruction pairs, and then the synchronization primitive corresponding to each virtual synchronization primitive is determined based on the virtual synchronization primitive, so that the synchronization primitive can be automatically inserted into the program, to ensure dependency between instructions that have a dependency relationship, improve efficiency of inserting the synchronization primitive into the program, and reduce programming difficulty for a programmer.

In a possible implementation, the virtual synchronization primitive includes a virtual set instruction and a virtual wait instruction. The synchronization primitive includes a set instruction and a wait instruction. The synchronization primitive is obtained by replacing a virtual ID in the virtual synchronization primitive with an event ID.

For example, the first virtual synchronization primitive includes a first virtual set instruction and a first virtual wait instruction, and the first virtual set instruction and the first virtual wait instruction each include the first virtual ID.

The first synchronization primitive includes a first set instruction and a first wait instruction. The first set instruction and the first wait instruction each include the first event ID. The first synchronization primitive is obtained by replacing the first virtual ID in the first virtual synchronization primitive with the first event ID. The first set instruction is executed after the source instruction in the first instruction pair is executed. A flag bit corresponding to the first event ID is set. The first wait instruction is used to determine, when being executed, whether the flag bit corresponding to the first event ID is set. When the flag bit corresponding to the first event ID is set, a destination instruction in the first instruction pair is executed.

In a possible implementation, the processing module is specifically configured to: select the first event ID from the event IDs corresponding to the two execution units that execute the first instruction pair; determine a second synchronization primitive that uses the first event ID last time; and when a happen-before relationship exists between the second synchronization primitive and the first virtual synchronization primitive, if it is determined that the first event ID can be assigned to the first virtual synchronization primitive, replace the first virtual ID in the first virtual synchronization primitive with the first event ID, to obtain the first synchronization primitive. The second synchronization primitive is obtained by replacing a virtual ID in a corresponding second virtual synchronization primitive with the first event ID. A second set instruction in the second synchronization primitive and the first set instruction in the first synchronization primitive are executed by a same execution unit. A second wait instruction in the second synchronization primitive and the first wait instruction in the first synchronization primitive are executed by a same execution unit.

In a possible implementation, the processing module is specifically configured to: select the first event ID from the event IDs corresponding to the two execution units that execute the first instruction pair; determine a second synchronization primitive that uses the first event ID last time; and when an unreachable relationship exists between the second synchronization primitive and the first virtual synchronization primitive, if it is determined that the first event ID can be assigned to the first virtual synchronization primitive, replace the first virtual ID in the first virtual synchronization primitive with the first event ID, to obtain the first synchronization primitive.

The second synchronization primitive is obtained by replacing a virtual ID in a corresponding second virtual synchronization primitive with the first event ID. A second set instruction in the second synchronization primitive and the first set instruction in the first synchronization primitive are executed by a same execution unit. A second wait instruction in the second synchronization primitive and the first wait instruction in the first synchronization primitive are executed by a same execution unit.

In a possible implementation, the processing module is specifically configured to: select the first event ID from the event IDs corresponding to the two execution units that execute the first instruction pair; determine a second synchronization primitive that uses the first event ID last time; and when no happen-before relationship or unreachable relationship exists between the second synchronization primitive and the first virtual synchronization primitive, after a third virtual synchronization primitive is inserted between the second synchronization primitive and the first virtual synchronization primitive, replace the first virtual ID in the first virtual synchronization primitive with the first event ID, to obtain the first synchronization primitive.

The third virtual synchronization primitive includes a third virtual set instruction and a third virtual wait instruction. The third virtual set instruction is inserted after the second wait instruction in the second synchronization primitive. The third virtual wait instruction is inserted before a first virtual set instruction in the first virtual synchronization primitive.

In a possible implementation, the apparatus further includes a merging module, configured to: obtain a currently active virtual ID at a first program point; and when a quantity of active virtual IDs is greater than N, merge virtual synchronization primitives to which the active virtual IDs belong, where N is a quantity of event IDs between two execution units, the active virtual ID is a virtual ID in a virtual synchronization primitive corresponding to an unfinished instruction pair when the program is executed to the first program point, virtual set instructions in the virtual synchronization primitives to which the active virtual IDs belong are executed by a same execution unit, and virtual wait instructions in the virtual synchronization primitives to which the active virtual IDs belong are executed by a same execution unit.

In a possible implementation, the merging module is specifically configured to: if a source instruction and a destination instruction in an instruction pair corresponding to a fourth virtual synchronization primitive that uses a second virtual ID are cross-iteration instructions, a source instruction and a destination instruction in an instruction pair corresponding to a fifth virtual synchronization primitive that uses a third virtual ID are cross-iteration instructions, a fourth virtual wait instruction in the fourth virtual synchronization primitive dominates a fifth virtual wait instruction in the fifth virtual synchronization primitive, and a fifth virtual set instruction in the fifth virtual synchronization primitive post-dominates a fourth virtual set instruction in the fourth virtual synchronization primitive, delete the fourth virtual set instruction in the fourth virtual synchronization primitive and the fifth virtual wait instruction in the fifth virtual synchronization primitive, and replace the third virtual ID in the fifth virtual set instruction in the fifth virtual synchronization primitive with the second virtual ID in the fourth synchronization primitive. The second virtual ID and the third virtual ID belong to the active virtual IDs.

In a possible implementation, the merging module is specifically configured to: if neither the source instruction nor the destination instruction in the instruction pair corresponding to each of the fourth virtual synchronization primitive and the fifth virtual synchronization primitive is a cross-iteration instruction, retain a target virtual set instruction and a target virtual wait instruction, delete virtual synchronization primitives that use the second virtual ID and the third virtual ID other than the target virtual set instruction and the target virtual wait instruction, and replace a virtual ID in the target virtual set instruction and the target virtual wait instruction with the second virtual ID. The target virtual set instruction is a 2^{nd} virtual set instruction that uses the second virtual ID or the third virtual ID and that is encountered in a process of traversing the program. The target virtual wait instruction is a 1^{st} virtual wait instruction that uses the second virtual ID or the third virtual ID and that is encountered in the process of traversing the program.

In a possible implementation, the apparatus further includes a redundancy removal module, configured to perform, based on a dominance relationship and/or a post-dominance relationship between virtual synchronization primitives corresponding to different instruction pairs, redundancy removal on the virtual synchronization primitives corresponding to the instruction pairs, where source instructions in the different instruction pairs are executed by a same execution unit, and destination instructions in the different instruction pairs are executed by a same execution unit.

Optionally, when the redundancy removal module performs redundancy removal on the virtual synchronization primitive, if a source instruction in a second instruction pair corresponding to an eighth virtual synchronization primitive whose virtual ID is a is the same as a source instruction in a third instruction pair corresponding to a ninth virtual synchronization primitive whose virtual ID is b, and if a virtual wait instruction in the eighth virtual synchronization primitive dominates a virtual wait instruction in the ninth virtual synchronization primitive, the ninth virtual synchronization primitive whose virtual ID is b is deleted. That the virtual wait instruction in the eighth virtual synchronization primitive dominates the virtual wait instruction in the ninth virtual synchronization primitive means that virtual wait instructions whose virtual IDs are a exist on paths from the source instruction in the third instruction pair to all virtual wait instructions whose virtual IDs are b.

Optionally, if a destination instruction in a second instruction pair corresponding to an eighth virtual synchronization primitive whose virtual ID is a is the same as a destination instruction in a third instruction pair corresponding to a ninth virtual synchronization primitive whose virtual ID is b, and if a virtual set instruction in the eighth virtual synchronization primitive post-dominates a virtual set instruction in the ninth virtual synchronization primitive, the ninth virtual synchronization primitive whose virtual ID is b is deleted. That the virtual set instruction in the eighth virtual synchronization primitive post-dominates the virtual set instruction in the ninth virtual synchronization primitive means that virtual set instructions whose virtual IDs are a exist on paths from a source instruction in the third instruction pair to the destination instruction in the third instruction.

Optionally, if a source instruction and a destination instruction in a second instruction pair corresponding to an eighth virtual synchronization primitive whose virtual ID is a are respectively different from a source instruction and a destination instruction in a third instruction pair corresponding to a ninth virtual synchronization primitive whose virtual ID is b, and if a virtual set instruction in the eighth virtual synchronization primitive post-dominates a virtual set instruction in the ninth virtual synchronization primitive, and a virtual wait instruction in the eighth virtual synchronization primitive dominates a virtual wait instruction in the ninth virtual synchronization primitive, the ninth virtual synchronization primitive whose virtual ID is b is deleted.

In a possible implementation, the insertion module is specifically configured to: insert a first virtual set instruction after a first source instruction in the first instruction pair, and insert a first virtual wait instruction before a first destination instruction in the first instruction pair.

Optionally, when neither the first source instruction nor the first destination instruction in the first instruction pair is in a loop, a first virtual set instruction is inserted between the first source instruction and an instruction next to the first source instruction, and a first virtual wait instruction is inserted between the first destination instruction and an instruction previous to the first destination instruction.

Optionally, when the first source instruction is in a loop L0 and the first destination instruction is not in an outermost loop L to which the first source instruction belongs, a first virtual set instruction corresponding to the first source instruction is inserted into an exit block of the outermost loop L.

In the foregoing case, the first virtual set instruction is inserted into the exit block of the outermost loop L, to avoid a case in which a same flag bit is set for a plurality of consecutive times in an execution process of a loop.

Optionally, when the first destination instruction is in a loop C0 and the first source instruction is not in an outermost loop C to which the first destination instruction belongs, a first virtual wait instruction corresponding to the first destination instruction is inserted into a preheader of the outermost loop C.

In the foregoing case, the loop is executed for a plurality of times. When the first virtual wait instruction is executed during a 1^{st} execution loop, the wait instruction has been reset. When the first virtual wait instruction is executed again, because there is no corresponding virtual set instruction in the loop, the program is blocked and cannot continue to be executed. The foregoing problem can be avoided by inserting the first virtual wait instruction into the preheader of the outermost loop C.

In a possible implementation, the insertion module is further configured to: if the first instruction pair includes instructions that have a cross-iteration dependency relationship, insert a first virtual wait instruction after a first virtual set instruction and insert a first virtual set instruction before the first virtual wait instruction. For example, a first virtual set instruction is inserted into a preheader of a loop to which the first instruction pair belongs, and a first virtual wait instruction is inserted into an exit block of the loop to which the first instruction pair belongs.

In a possible implementation, the insertion module is further configured to: if the first source instruction and the first destination instruction in the first instruction pair are unreachable to each other, insert a first virtual wait instruction before a first virtual set instruction, and insert a first virtual set instruction after a first virtual wait instruction. For example, a first virtual wait instruction is inserted before a first virtual set instruction of a basic block to which the first virtual set instruction belongs, and a first virtual set instruction is inserted after a first virtual wait instruction of the basic block to which the first virtual wait instruction belongs.

In a possible implementation, the insertion module is further configured to: when a first loop does not have a preheader and an exit block, add the preheader and the exit block to the first loop, where the first loop is any loop in the program.

In a possible implementation, the insertion module is further configured to: when a last instruction in a first basic block is an indirect jump instruction, a quantity of successors of the first basic block is greater than 1, a second basic block is a successor of the first basic block, and the second basic block post-dominates the first basic block, add a third basic block between the first basic block and the second basic block, replace, with the third basic block, the second basic block in the successors of the first basic block in a control flow graph corresponding to the program, and replace a first basic block in input basic blocks of a PHI node of the second basic block with the third basic block.

In a possible implementation, the insertion module is further configured to: traverse a basic block corresponding to the program; and for a currently traversed basic block, for example, a fourth basic block, when the fourth basic block has a plurality of precursors, insert a virtual set instruction or a virtual wait instruction into the plurality of precursors based on sequence lengths of the plurality of precursors, so that a virtual set instruction and a virtual wait instruction on any execution path of the program are in pairs, where a sequence length corresponding to one precursor is a sum of a quantity of virtual set instructions and a quantity of virtual wait instructions that are in the precursor and for which a source pipeline and a destination pipeline are the same; and if the fourth basic block has a plurality of precursors, first obtain an entry state of the fourth basic block and the sequence lengths of the precursors; then, for any one of the precursors, for example, a fifth basic block, if a remainder of a modulo-2 operation of a sequence length of the fifth basic block is equal to a remainder of a modulo-2 operation of the entry state of the fourth basic block, determine that no virtual set instruction or virtual wait instruction needs to be inserted into the fifth basic block, where a sequence length of a precursor is a quantity of virtual set instructions and virtual wait instructions in the precursor that are executed by a first pipeline pair; to be specific, when a virtual synchronization primitive corresponding to the first pipeline pair is improved, the sequence length of the precursor is a quantity of virtual set primitives and virtual wait instructions whose source pipeline is a pipeline 1 and destination pipeline is a pipeline 2; and an entry state of a current basic block is a value with a maximum sequence length among all precursors of the current basic block; or if a remainder of a modulo-2 operation of a sequence length of the fifth basic block is not equal to a remainder of a modulo-2 operation of the entry state of the fourth basic block, determine that a virtual set instruction or a virtual wait instruction needs to be inserted into the fifth basic block, where specifically, if the entry state of the fourth basic block cannot be exactly divided by 2, a virtual set instruction needs to be inserted into the fifth basic block, and a virtual ID in the virtual set instruction is the same as a virtual ID in a first virtual wait instruction in the fourth basic block; or if the entry state of the fourth basic block can be exactly divided by 2, a virtual wait instruction needs to be inserted into the fifth basic block, and a virtual ID in the virtual wait instruction is the same as a virtual ID in a virtual set instruction before the virtual wait instruction.

In a possible implementation, the apparatus further includes an analysis module, configured to perform read-after-write analysis, write-after-read analysis, and write-after-write analysis on the program, to determine a plurality of instruction pairs that have a dependency relationship in the program.

According to a third aspect, this application provides an accelerator card. The accelerator card includes a processor and a power supply circuit. The power supply circuit is configured to supply power to the accelerator card. The processor is configured to implement the method according to any one of the first aspect or the possible implementations of the first aspect.

According to a fourth aspect, this application provides a computing device, including a central processing unit, an accelerator card, and a memory. The memory is configured to store instructions. The central processing unit or the accelerator card is configured to execute the instructions. When the central processing unit or the accelerator card executes the instructions, the method according to any one of the first aspect or the possible implementations of the first aspect is implemented.

According to a fifth aspect, this application provides a computer program product. When the computer program product runs on a server, the server is enabled to perform the method according to any one of the first aspect or the possible implementations of the first aspect.

According to a sixth aspect, this application provides a computer-readable storage medium. The computer-readable storage medium stores instructions. When the instructions are run on a computing device, the computing device is enabled to implement the method according to any one of the first aspect or the possible implementations of the first aspect.

### BRIEF DESCRIPTION OF THE DRAWINGS

To describe technical solutions in embodiments of this application more clearly, the following briefly describes the accompanying drawings for describing embodiments. It is clear that the accompanying drawings in the following descriptions show merely some embodiments of this application, and a person of ordinary skill in the art may still derive other drawings from these accompanying drawings without creative efforts.

FIG. 1 is a schematic flowchart of a method for inserting a synchronization primitive according to an embodiment of this application;

FIG. 2 is a diagram in which a first instruction pair is in a control flow graph according to an embodiment of this application;

FIG. 3 is a diagram in which another first instruction pair is in a control flow graph according to an embodiment of this application;

FIG. 4 is a diagram of instructions that have a cross-iteration dependency relationship according to an embodiment of this application;

FIG. 5 is a diagram in which a source instruction and a destination instruction are unreachable to each other according to an embodiment of this application;

FIG. 6 is a diagram in which a reverse virtual synchronization primitive is inserted according to an embodiment of this application;

FIG. 7 is a diagram in which a control flow graph is normalized according to an embodiment of this application;

FIG. 8 is a diagram in which a branch structure is normalized according to an embodiment of this application;

FIG. 9 is a diagram in which a virtual synchronization primitive is improved according to an embodiment of this application;

FIG. 10 is a schematic flowchart in which a virtual synchronization primitive is improved according to an embodiment of this application;

FIG. 11 is another diagram in which a virtual synchronization primitive is improved according to an embodiment of this application;

FIG. 12 is a schematic flowchart in which redundancy removal is performed on a virtual synchronization primitive according to an embodiment of this application;

FIG. 13 is a diagram in which redundancy removal is performed on a virtual synchronization primitive according to an embodiment of this application;

FIG. 14 is another diagram in which redundancy removal is performed on a virtual synchronization primitive according to an embodiment of this application;

FIG. 15 is still another diagram in which redundancy removal is performed on a virtual synchronization primitive according to an embodiment of this application;

FIG. 16 is a diagram of an apparatus for inserting a synchronization primitive according to an embodiment of this application;

FIG. 17 is a diagram of another apparatus for inserting a synchronization primitive according to an embodiment of this application;

FIG. 18 is a diagram of an accelerator card according to an embodiment of this application; and

FIG. 19 is a diagram of a computing device according to an embodiment of this application.

### DETAILED DESCRIPTION OF ILLUSTRATIVE EMBODIMENTS

The following describes the technical solutions of this application with reference to the accompanying drawings.

With rapid development of artificial intelligence represented by deep learning, conventional CPUs cannot meet increasing computing power requirements of various AI applications. Therefore, various heterogeneous accelerator cards are developed to accelerate AI computing.

In terms of hardware design, for a heterogeneous accelerator card, a plurality of functional units are usually combined, and different functional units perform respective functions to form different independently executed pipelines, and cooperate with each other to implement different instruction functions under unified scheduling of system software and hardware, to optimize computing efficiency, and strike a balance between performance and completeness. For example, in terms of computing, there are three types of execution units: scalar, vector, and cube, namely, three pipelines. In terms of data transmission, an execution unit is specially responsible for data flow between different storage components and computing components.

In terms of software, many instructions depend on each other. To be specific, one instruction depends on an execution result of another instruction, and the instructions that depend on each other are executed in sequence. For example, an instruction A is responsible for loading data, and an instruction B performs computing based on a loading result of the instruction A. In this case, the instruction B depends on the instruction A, and the instruction B can be executed only after the instruction A.

In the conventional CPU, in terms of hardware, dependency between instructions is ensured through a complex logic design, dynamic scheduling of a scoreboard, register renaming, and the like, and parallelism of the instructions is improved as much as possible. This ensures program correctness and improves program performance.

Different from the conventional CPU, to use a limited chip area and maximize computing power, the heterogeneous accelerator card has simpler control and scheduling logic than the CPU, and does not have complex hardware logic to ensure dependency between instructions. In this case, a programmer needs to insert a synchronization primitive to ensure the dependency between the instructions. However, when the programmer needs to insert the synchronization primitive in a programming process to implement the dependency between the instructions, the programmer needs to have sufficient understanding of underlying hardware to complete programming based on the heterogeneous accelerator card. This greatly increases programming difficulty and workload of the programmer and is likely to cause an error.

Embodiments of this application provide a method for automatically adding a synchronization primitive to a program, so that after a programmer completes programming, in a process in which a compiler compiles the program to generate an executable file, a synchronization primitive can be inserted into the program to ensure correctness of program execution. This reduces programming difficulty and workload of the programmer, improves work efficiency, and avoids an error that may occur when the programmer inserts the synchronization primitive.

The following first describes explanations of related terms provided in embodiments of this application. The terms used in embodiments of this application are merely used to describe specific embodiments of this application, but are not intended to limit the present invention. The following first describes some terms that may be used in embodiments of this application.

Instruction pair: The instruction pair is a pair of instructions that have a dependency relationship. A depended instruction is referred to as a source instruction, and an instruction that depends on the source instruction is referred to as a destination instruction. For example, an instruction A is an instruction for loading data, and an instruction B performs computing based on the data loaded by the instruction A. In this case, the instruction B depends on the instruction A, the instruction A is a source instruction, and the instruction B is a destination instruction.

Pipeline: The pipeline is an execution unit in a heterogeneous accelerator card. In terms of hardware design, for the heterogeneous accelerator card, a plurality of functional units are usually combined, and different functional units perform different functions to form different independently executed pipelines, and cooperate with each other to implement different instruction functions under unified scheduling of system software and hardware, to optimize computing efficiency. For example, in terms of computing, some heterogeneous accelerator cards include three types of execution units: scalar, vector, and cube, namely, three pipelines. In terms of data transmission, an execution unit is specially responsible for data flow between different storage components and computing components.

Pipeline pair: The pipeline pair includes two different pipelines, and the different pipelines have pipeline identities (ID). In embodiments of this application, there are two types of instruction pairs. For one type of instruction pair, a source instruction and a destination instruction in the instruction pair are executed by a same pipeline. Another type of instruction pair is a pipeline-cross instruction pair, that is, a source instruction and a destination instruction in the instruction pair are respectively executed by different pipelines. When an instruction pair is a cross-pipeline instruction pair, two pipelines that execute the type of instruction pair are a pipeline pair. In the pipeline pair, a pipeline that executes a source instruction is referred to as a source pipeline, and a pipeline that executes a destination instruction is referred to as a destination pipeline.

It should be noted that, if an accelerator card includes three pipelines and identities of the three pipelines are 1, 2, and 3 respectively, and if a pipeline pair that executes an instruction pair is represented in a form of (a source pipeline ID, a destination pipeline ID), the accelerator card includes six pipeline pairs: (1, 2), (1, 3), (2, 1), (2, 3), (3, 1), and (3, 2). That is, if a pipeline pair that executes an instruction pair is (1, 2) and a pipeline pair that executes another instruction pair is (2, 1), the two pipeline pairs are different pipeline pairs.

Event ID: The event ID indicates a hardware flag bit (briefly referred to a flag bit hereinafter) in an accelerator card. In embodiments of this application, each pipeline pair corresponds to a plurality of flag bits, and each flag bit corresponds to one event ID. It should be understood that, for one accelerator card, a quantity of flag bits corresponding to each pipeline pair is fixed and limited. In view of this, a quantity of event IDs corresponding to each pipeline pair is a preset fixed value, that is, the quantity of event IDs is fixed and limited. For example, one pipeline pair corresponds to four flag bits, and event IDs of the four flag bits are 1 to 4 respectively. Functions of the flag bit and the event ID are described below, and details are not described herein again.

Embodiments of this application provide two types of synchronization primitives.

A first type of synchronization primitive describes a dependency relationship between pipeline-across instruction pairs. The first type of synchronization primitive includes a set instruction and a wait instruction. The set instruction is located after a source instruction and is executed by a source pipeline. The wait instruction is located before a destination instruction and is executed by a destination pipeline. Each pipeline pair corresponds to flag bits. Each flag bit corresponds to an event ID. The set instruction and the wait instruction each include the event ID. A set instruction and a wait instruction in one synchronization primitive include a same event ID.

The flag bit is used to indicate whether a depended instruction (source instruction) in an instruction pair is completed. In an execution process of the program, after the source instruction is finished, the set instruction can be executed and a flag bit corresponding to the event ID in the set instruction is set. Before the destination instruction is executed, it is determined, by executing the wait instruction, whether a flag bit corresponding to the event ID in the wait instruction is set, where if the flag bit corresponding to the event ID in the wait instruction is already set, it indicates that the source instruction is finished; and if the flag bit corresponding to the event ID in the wait instruction is not set, the destination instruction is not executed until a corresponding flag bit is set, so as to ensure that the source instruction is finished before the destination instruction is executed.

A second type of synchronization primitive describes a dependency between two instructions executed by a same pipeline. If the synchronization primitive is encountered in an execution process of the program, it indicates that an instruction before the synchronization primitive in a pipeline waits to be finished.

For ease of description, in embodiments of this application, the set instruction is represented by set_flag, and the wait instruction is represented by wait_flag. A format of the set instruction is set_flag (a source pipeline ID, a destination pipeline ID, an event ID), and a format of the wait instruction is wait_flag (a source pipeline ID, a destination pipeline ID, an event ID).

For example, if the following program exists:

Load A;
set_flag(1,2,4);
...
wait_flag(1,2,4);
C=A+1;

In the foregoing program, the instructions Load A and C=A+1 are a pair of instructions that have a dependency relationship, Load A is a source instruction, and C=A+1 is a destination instruction. The instruction pair is executed by a pipeline pair: a pipeline 1 and a pipeline 2. The pipeline 1 is a source pipeline, and the pipeline 2 is a destination pipeline. After finishing the source instruction, the pipeline 1 executes the set instruction set_flag(1,2,4) to set a flag bit whose event ID is 4 in flag bits corresponding to the pipeline 1 and the pipeline 2. When the program executes the wait instruction wait_flag(1,2,4), it is queried whether the flag bit whose event ID is 4 is set, where if it is determined that the flag bit is set, C=A+1 is executed; and if the flag bit is not set, the pipeline 2 does not execute subsequent C=A+1 until the foregoing flag bit is set.

Virtual synchronization primitive: The virtual synchronization primitive means that an event ID in a set instruction and a wait instruction in the foregoing synchronization primitive is virtual. In embodiments of this application, an event ID in a virtual synchronization primitive is referred to as a virtual ID, a set instruction that uses the virtual ID is referred to as a virtual set instruction, and a wait instruction that uses the virtual ID is referred to as a virtual wait instruction. A quantity of virtual IDs that can be used by any pipeline pair is greater than a quantity of event IDs corresponding to the pipeline pair.

It should be understood that, because a quantity of flag bits corresponding to any pipeline pair is limited and fixed, for example, there are only N flag bits between two pipelines, a value of the foregoing event ID ranges from 1 to N. However, a quantity of determined instruction pairs in any pipeline pair is usually greater than N. If a synchronization primitive is inserted into an instruction pair, an event ID is simply used cyclically. For example, if a quantity of event IDs is 3, synchronization primitives corresponding to the first three instruction pairs use one event ID, and synchronization primitives corresponding to the following three instruction pairs use the remaining two event IDs. In this way, the following situation may occur on two synchronization primitives (for example, a synchronization primitive A and a synchronization primitive B) that use a same event ID: A set instruction of the synchronization primitive A sets a flag bit corresponding to the event ID, but the program has not executed a wait instruction of the synchronization primitive A, that is, the flag bit corresponding to the event ID is still occupied. In this case, the program may execute a set instruction of the synchronization primitive B, and the set instruction of the synchronization primitive B needs to set the flag bit. This causes a program execution error.

Therefore, in the method for inserting a synchronization primitive into an instruction pair provided in this application, a virtual synchronization primitive needs to be first inserted into the instruction pair, then an event ID corresponding to a virtual ID in each virtual synchronization primitive is determined, and the virtual ID in the virtual synchronization primitive is replaced with the corresponding event ID, to obtain a synchronization primitive corresponding to each instruction pair. “Executing a virtual set instruction/a virtual wait instruction” described in a process of describing the method for inserting a synchronization primitive provided in this application truly means that “after a virtual ID in each virtual synchronization primitive is replaced with an event ID to obtain a synchronization primitive corresponding to each instruction pair, the program is executed to a program point where the virtual set instruction/virtual wait instruction is located”.

Loop header: All edges that enter a loop from outside the loop point to the loop header. One loop has only one loop header.

Preheader: The preheader is a precursor of a loop header of a loop in a control flow graph and is located outside the loop. In a standardized control flow graph, a loop header of one loop has only one precursor, namely, a preheader, and the preheader has only one successor, namely, a loop header.

Exit block: The exit block is a basic block (BB) corresponding to a preheader and is located after an exiting block of a loop. All precursors of the exit block are in the loop.

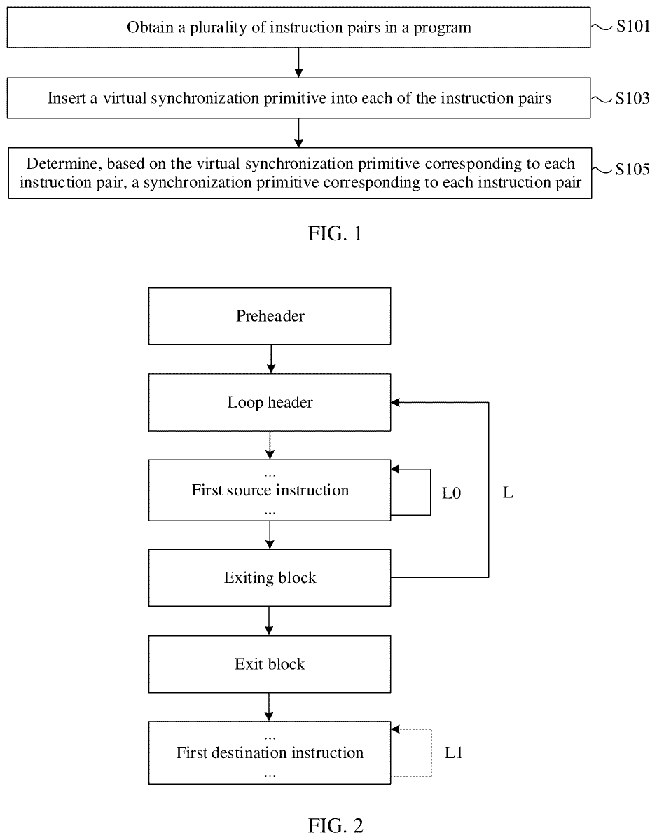

The following describes a method for inserting a synchronization primitive provided in embodiments of this application with reference to the accompanying drawings. FIG. 1 is a schematic flowchart of a method for inserting a synchronization primitive according to an embodiment of this application.

S101: Obtain a plurality of instruction pairs in a program.

Before a synchronization primitive is inserted into an instruction pair, instructions in the program that have a dependency relationship need to be first determined. In embodiments of this application, the instruction pair in the program may be found through read-after-write (RAW) analysis, write-after-read (WAR) analysis, and write-after-write (WAW) analysis.

In read-after-write analysis, the program is traversed. If a write operation, for example, a first write operation, is encountered, a first output operand in a first write operation instruction is obtained and a definition point of the first output operand is determined. If a read operation, for example, a first read operation, is encountered, a first input operand in a first read operation instruction is obtained and a definition point of the first input operand is determined. If the definition point of the first input operand is the same as the definition point of the first output operand, it is determined that the first write operation instruction and the first read operation instruction are instructions that have a dependency relationship, where the first write operation instruction is a source instruction, and the first read operation instruction is a destination instruction.

In read-after-write analysis, the program is traversed. If a write operation, for example, a second write operation, is encountered, a definition point of a second write operation instruction kill (kill) is obtained. If a corresponding second read operation instruction exists at the definition point of the second write operation instruction kill, it is determined that the second read operation instruction and the second write operation instruction are instructions that have a dependency relationship, where the second read operation instruction is a source instruction, and the second write operation instruction is a destination instruction.

In write-after-write analysis, the program is traversed. If a write operation, for example, a third write operation, is encountered, a definition point of a third write operation instruction kill is obtained. If the definition point of the third write operation instruction kill corresponds to a fourth write operation instruction, it is determined that the third write operation instruction and the fourth write operation instruction are instructions that have a dependency relationship, where the fourth write operation instruction is a source instruction, and the third write operation instruction is a destination instruction. For example, the third write operation instruction is a=5. Before this instruction, there are two write operations: a=3 and a=4. If a=5 is performed, a=3 and a=4 are overwritten or killed. In this case, two instruction pairs may be determined: a=3 and a=5, and a=4 and a=5, where a=5 is a destination instruction.

It should be understood that, in embodiments of this application, a definition point corresponding to an operand in each instruction can be determined through basic pointer analysis and fixed value arrival analysis.

In a possible implementation, after the instruction pairs in the program are determined, the instruction pairs may be traversed according to a reverse post order method, so that the instruction pairs are sorted and a sequence number is assigned to each instruction pair.

S103: Insert a virtual synchronization primitive into each of the instruction pairs.

Before the synchronization primitive is added to the instruction pair, the virtual synchronization primitive needs to be added to each instruction pair. It should be noted that, in embodiments of this application, a method for inserting a virtual synchronization primitive into an instruction pair to be described below means inserting a virtual synchronization primitive into an instruction pair executed across a pipeline, and is described by using an example in which a synchronization primitive is inserted into an instruction pair executed by one pipeline pair. Values of virtual IDs used by virtual synchronization primitives corresponding to instruction pairs executed by a same pipeline pair increase sequentially.

For ease of description, all instruction pairs in embodiments of this application are executed by a first pipeline pair, and the first pipeline pair is any pipeline pair. An example in which a source pipeline in the first pipeline pair is a pipeline 1, and a destination pipeline in the first pipeline pair is a pipeline 2 is used. The following describes a method for inserting virtual synchronization primitives into instruction pairs executed by a same pipeline pair.

In embodiments of this application, when a virtual synchronization primitive is inserted into an instruction pair, a virtual set instruction is inserted after a source instruction and a virtual wait instruction is inserted before a destination instruction. Specifically, there may be the following two cases in which the virtual synchronization primitive is inserted into the instruction pair.

(1) Neither the source instruction nor the destination instruction in the instruction pair is in a loop.

For a first instruction pair, when neither a first source instruction nor a first destination instruction in the first instruction pair is in a loop, a first virtual set instruction is inserted between the first source instruction and an instruction next to the first source instruction, and a first virtual wait instruction is inserted between the first destination instruction and an instruction previous to the first destination instruction. For example, if the first instruction pair is an instruction pair whose sequence number is 1 in instruction pairs executed by the first pipeline pair, the added first virtual set instruction is set_flag(1,2,1) and the first virtual wait instruction is wait_flag(1,2,1). If the first instruction pair is an instruction pair whose sequence number is n in instruction pairs executed by the first pipeline pair, the added first virtual set instruction is set_flag(1,2,n) and the first virtual wait instruction is wait_flag(1,2,n), where n is a positive integer.

(2) At least one of the source instruction and the destination instruction in the instruction pair is in a loop.

When at least one of a first source instruction and a first destination instruction in a first instruction pair is in a loop, a location at which a first virtual set instruction corresponding to the first source instruction is inserted and a location at which a first virtual wait instruction corresponding to the first destination instruction is inserted need to be determined based on a loop to which the first source instruction belongs or a loop to which the first destination instruction belongs.

In a possible implementation, FIG. 2 is a diagram in which a first instruction pair is in a control flow graph according to an embodiment of this application. When a first source instruction is in a loop L0 and a first destination instruction is not in an outermost loop L to which the first source instruction belongs, a first virtual set instruction corresponding to the first source instruction may be inserted into an exit block of the outermost loop L. When the first destination instruction is not in the outermost loop L to which the first source instruction belongs, this situation includes that the first destination instruction is not in the loop, and the outermost loop L does not include a basic block to which the first destination instruction belongs; and the first destination instruction is in the loop L1, but the loop L1 is not in the outermost loop L to which the first source instruction belongs.

Optionally, when the source instruction or the destination instruction is in a loop, a parent loop of the loop may be obtained according to an instruction. For example, the parent loop of the loop is obtained by using getParentLoop( ), and an outermost loop of the loop may be obtained by using getParentLoop( ) once or a plurality of times.

For example, in FIG. 2, a square represents a basic block in a control flow graph (CFG). If a first virtual set instruction is inserted between the first source instruction and an instruction next to the first source instruction, the program executes the set instruction once each time the loop L0 or the outermost loop L is executed, and sets a flag bit corresponding to an event ID in the set instruction. Such a case in which a same flag bit is set for a plurality of consecutive times is not allowed in hardware. Therefore, the first virtual set instruction needs to be placed outside the outermost loop L, for example, the first virtual set instruction is inserted into the exit block of the outermost loop L.

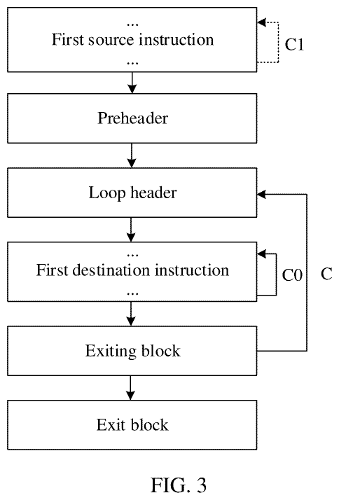

In a possible implementation, FIG. 3 is a diagram in which another first instruction pair is in a control flow graph according to an embodiment of this application. When a first destination instruction is in a loop C0 and a first source instruction is not in an outermost loop C to which the first destination instruction belongs, a first virtual wait instruction corresponding to the first destination instruction may be inserted into a preheader of the outermost loop C. When the first source instruction is not in the outermost loop C to which the first destination instruction belongs, this situation includes that the first source instruction is not in the loop and the outermost loop C does not include the first source instruction either; and the first source instruction is in the loop C1, but the loop C1 is not in the outermost loop C to which the first destination instruction belongs.

For example, in FIG. 3, if a first virtual wait instruction is inserted between the first destination instruction and an instruction previous to the first destination instruction, the program executes the first virtual wait instruction once each time the loop C0 or the outermost loop C is executed. However, when the first virtual wait instruction is executed for the first time, a flag bit corresponding to the first virtual wait instruction has been reset; in this case, when the first virtual wait instruction is executed again, there is no corresponding virtual set instruction in the loop. Consequently, the program is blocked and cannot continue to be executed. Therefore, the first virtual wait instruction needs to be placed outside the outermost loop C, for example, the first virtual wait instruction is inserted into the preheader of the outermost loop C.

After a virtual synchronization primitive is inserted into an instruction pair according to the foregoing method, additional virtual synchronization primitives need to be inserted into some instruction pairs. For example, for an instruction pair in which a source instruction and a destination instruction are cross-iteration instructions, or an instruction pair in which a source instruction and a destination instruction are unreachable to each other, a corresponding additional virtual synchronization primitive needs to be inserted to ensure that a corresponding virtual wait instruction is executed each time after a virtual set instruction is executed, and a corresponding virtual set instruction is executed each time before a virtual wait instruction is executed, so as to ensure that the program can be executed normally. Specifically, there may be the following two cases in which an additional virtual synchronization primitive is inserted into an instruction pair.

(3) A source instruction and a destination instruction in the instruction pair are instructions that have a cross-iteration dependency relationship.

For the source instruction and the destination instruction that have a cross-iteration dependency relationship, in a process of executing an (i+1)^{th} loop, execution of the destination instruction depends on an execution result obtained by executing the source instruction before the loop, where i is a positive integer greater than or equal to 1.

In embodiments of this application, in (1) or (2), a corresponding virtual synchronization primitive can be inserted into instructions that have a cross-iteration dependency relationship. However, for the instructions that have a cross-iteration dependency relationship, an additional virtual synchronization primitive needs to be inserted, and a virtual ID in the additional virtual synchronization primitive is the same as a virtual ID in the virtual synchronization primitive inserted into the instruction pair based on (1) or (2), to ensure that a corresponding virtual wait instruction is executed each time after a virtual set instruction is executed, and a corresponding virtual set instruction is executed each time before a virtual wait instruction is executed, thereby ensuring that the program can be executed normally. The foregoing “corresponding” means that a source pipeline, a destination pipeline, and a virtual ID in the virtual set instruction are the same as those in the virtual wait instruction.

If the first instruction pair includes instructions that have a cross-iteration dependency relationship, a first virtual wait instruction is inserted after the first virtual set instruction, and a first virtual set instruction is inserted before the first virtual wait instruction. For example, a first virtual set instruction is inserted into a preheader of a loop to which the first instruction pair belongs, and a first virtual wait instruction is inserted into an exit block of the loop to which the first instruction pair belongs.

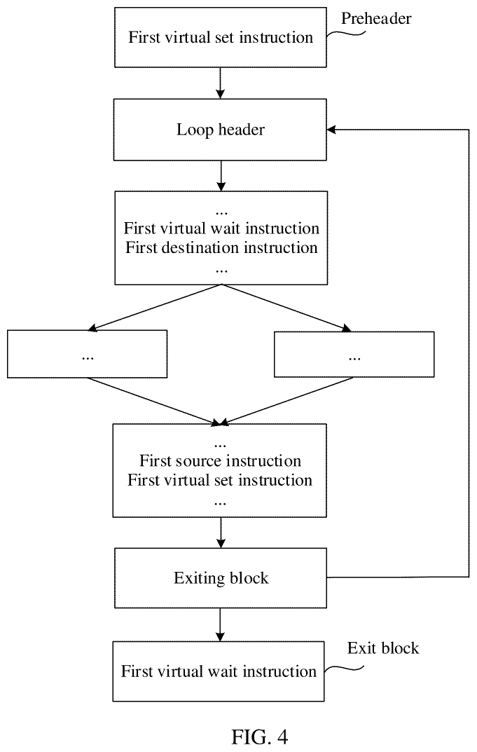

FIG. 4 is a diagram of instructions that have a cross-iteration dependency relationship according to an embodiment of this application. In a first instruction pair shown in FIG. 4, both a first source instruction and a first destination instruction belong to one loop. According to the method described in (1), a first virtual set instruction is inserted after the first source instruction, and a first virtual wait instruction is inserted before the first destination instruction. If no additional virtual synchronization primitive is inserted in this case, in a process of executing a loop to which the first instruction pair belongs for the first time, when the first virtual wait instruction is executed, because the first virtual set instruction is not executed before the first virtual wait instruction, a flag bit corresponding to a virtual ID in the first virtual wait instruction is not set. Consequently, the program cannot continue to be executed. In this case, a first virtual set instruction needs to be inserted before the first virtual wait instruction. If only the first virtual set instruction is inserted, in a process of executing the last loop, after the first virtual set instruction in the loop is executed, a corresponding flag bit is set. In this case, the program exits the loop, and the flag bit is not released and is always in a set state. In this case, a first virtual wait instruction needs to be inserted after the first virtual set instruction.

(4) A source instruction and a destination instruction in the instruction pair are unreachable to each other.

That the source instruction and the destination instruction are unreachable to each other means that the source instruction is unreachable to the destination instruction, and the destination instruction is unreachable to the source instruction. For example, the source instruction and the destination instruction are in different branches after a judgment statement, and only one the source instruction or the destination instruction is executed in a process of executing a loop.

In embodiments of this application, in (1) or (2), a corresponding virtual synchronization primitive can be inserted between a source instruction and a destination instruction that are unreachable to each other. However, for the source instruction and the destination instruction that are unreachable to each other, an additional virtual synchronization primitive needs to be inserted, to avoid continuous execution of a virtual set instruction or a virtual wait instruction, and a virtual ID in the additional virtual synchronization primitive is the same as a virtual ID in a virtual synchronization primitive inserted according to (1) or (2). If the first source instruction and the first destination instruction in the first instruction pair are unreachable to each other, a first virtual wait instruction is inserted before the first virtual set instruction, and a first virtual set instruction is inserted after the first virtual wait instruction. For example, a first virtual wait instruction is inserted before a first virtual set instruction of a basic block to which the first virtual set instruction belongs, and a first virtual set instruction is inserted after a first virtual wait instruction of the basic block to which the first virtual wait instruction belongs.

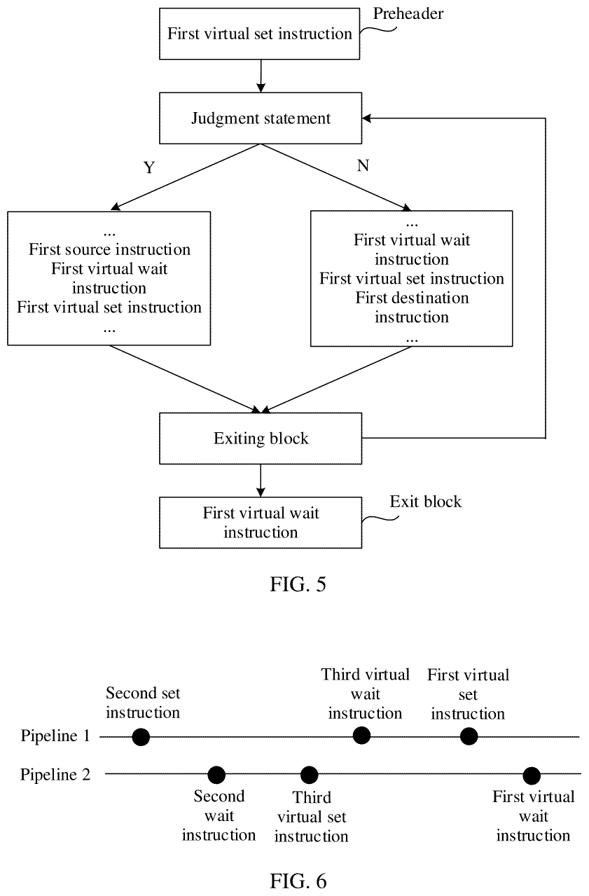

For example, FIG. 5 is a diagram in which a source instruction and a destination instruction are unreachable to each other according to an embodiment of this application. In a first instruction pair shown in FIG. 5, both a first source instruction and a first destination instruction belong to one loop, and are in different branches. After a first virtual set instruction is inserted after the first source instruction and a first virtual wait instruction is inserted before the first destination instruction according to the method described in (1), if no additional virtual synchronization primitive is inserted in this case, there may be a case where successive virtual set instructions or successive virtual wait instructions are executed. For example, a same branch is executed in two adjacent loops. In addition, in the example shown in FIG. 5, the first source instruction and the first destination instruction have a cross-iteration dependency relationship. In this case, a first virtual set instruction is inserted into a preheader of a loop to which the first instruction pair belongs, and a first virtual wait instruction is inserted into an exit block of the loop to which the first instruction pair belongs. If no first virtual wait instruction is inserted before a first virtual set instruction of a basic block to which the first source instruction belongs, and no first virtual set instruction is inserted after a first virtual wait instruction of a basic block to which the first destination instruction belongs, when a loop is entered, if a branch on the left is executed for the first time, the first virtual set instruction is continuously executed. Before the last loop exits, a branch on the right is executed, and the first virtual wait instruction is continuously executed.

S105: Determine, based on the virtual synchronization primitive corresponding to each instruction pair, a synchronization primitive corresponding to each instruction pair.

After the virtual synchronization primitive is inserted into each instruction pair, in an actual execution process of the program, because an actual flag bit of an accelerator card cannot be queried based on a virtual ID, a virtual ID in the virtual synchronization primitive needs to be replaced with an event ID, to obtain a synchronization primitive that can be executed during actual running of the program.

The following describes a method for determining, based on the virtual synchronization primitive corresponding to each instruction pair, the synchronization primitive corresponding to each instruction pair by using an example in which a corresponding event ID is determined based on a virtual ID in a first virtual synchronization primitive corresponding to the first instruction pair.

In a process of replacing a virtual ID in the virtual synchronization primitive with an event ID, each instruction in the program is traversed. When the first virtual synchronization primitive (the first virtual set instruction or the first virtual wait instruction) that uses a first virtual ID is encountered, it is first determined whether an event ID has been assigned to the first virtual synchronization primitive. If no event ID is assigned to the first virtual synchronization primitive, an event ID assigned to an active virtual ID at a current program point is first determined, and an event ID assigned to a currently active virtual ID is removed from all event IDs corresponding to the first pipeline pair, to obtain an event ID available to the current program point. The active virtual ID is a virtual ID in a virtual synchronization primitive corresponding to an instruction pair that is in the first pipeline pair and that is not finished when the program runs to the current program point.

In a case in which it is determined that an available event ID exists at the current program point, a first event ID is selected from a currently available event ID, then a second synchronization primitive that uses the first event ID last time is found, and it is determined whether a happen-before relationship or an unreachable relationship exists between the second synchronization primitive and the first virtual synchronization primitive. If the happen-before relationship or the unreachable relationship exists between the second synchronization primitive and the first virtual synchronization primitive, the first event ID is assigned to the first virtual synchronization primitive. If no happen-before relationship or unreachable relationship exists between the second synchronization primitive and the first virtual synchronization primitive, a next available event ID is selected, and the foregoing determining step continues until an event ID that meets the foregoing relationship is found from the available event ID. Then the event ID is assigned to the first virtual synchronization primitive. The second synchronization primitive is obtained by replacing a virtual ID in one virtual synchronization primitive with the first event ID.

If the available event ID does not exist at the current program point or the available event ID exists, but in the available event ID, no happen-before relationship or unreachable relationship exists between the first virtual synchronization primitive and a synchronization primitive that uses the event ID last time, an event ID, for example, the first event ID, is selected from the event IDs corresponding to the first pipeline pair. Then, a second synchronization primitive that uses the first event ID last time is determined, and a reverse third virtual synchronization primitive is inserted between the second synchronization primitive and the first virtual synchronization primitive, to ensure that a happen-before relationship exists between the second synchronization primitive and the first virtual synchronization primitive. Then, the first event ID is assigned to the first virtual synchronization primitive, and the virtual ID in the first virtual synchronization primitive is replaced with the first event ID, so that a first synchronization primitive corresponding to the first instruction pair can be obtained. A source pipeline in the third virtual synchronization primitive is a destination pipeline in the first virtual synchronization primitive, and a destination pipeline in the third virtual synchronization primitive is a source pipeline in the first virtual synchronization primitive. To be specific, a second set instruction in the second synchronization primitive, a first virtual set instruction in the first virtual synchronization primitive, and a third virtual wait instruction in the third virtual synchronization primitive are executed by a same execution unit; and a second wait instruction in the second synchronization primitive, a first virtual wait instruction in the first virtual synchronization primitive, and a third virtual set instruction in the third virtual synchronization primitive are executed by a same execution unit.

FIG. 6 is a diagram in which a reverse virtual synchronization primitive is inserted according to an embodiment of this application. In FIG. 6, for a first pipeline pair, a source pipeline is a pipeline 1, and a destination pipeline is a pipeline 2.

It should be noted that, in a process of replacing a virtual ID in a virtual synchronization primitive with an event ID, whether the foregoing available event ID exists may not be determined, and an event ID is directly assigned to the virtual synchronization primitive according to the foregoing method of “the available event ID does not exist at the current program point”.

It should be understood that, if a virtual ID in a virtual synchronization primitive corresponding to the first pipeline pair is replaced with an event ID to obtain a synchronization primitive, virtual IDs are replaced with event IDs in sequence according to an execution sequence. For example, a quantity of event IDs is 3. According to an execution sequence, the first three executed virtual synchronization primitives each use one event ID, the next three executed virtual synchronization primitives each use one event ID, and so on, to obtain a synchronization primitive corresponding to each virtual synchronization primitive. During program execution, the following situation may occur on two synchronization primitives (for example, a synchronization primitive C and a synchronization primitive D) that use a same event ID: A set instruction of the synchronization primitive C sets a flag bit corresponding to the event ID, but the program has not executed a wait instruction of the synchronization primitive C, that is, the flag bit corresponding to the event ID is still occupied. In this case, the program may execute a set instruction of the synchronization primitive D, and the set instruction of the synchronization primitive D needs to set the flag bit. This causes a program execution error. Therefore, when a current virtual ID is replaced with an event ID, it needs to be ensured that when the program executes an instruction corresponding to the current virtual ID, a synchronization primitive that uses the event ID last time has been finished. In this way, after the virtual synchronization primitive is replaced with the synchronization primitive, it can be ensured that when the program is executed to any program point, a same event ID is not used by two synchronization primitives, so as not to cause a program execution error.

In a possible implementation, after the instruction pair in the program is determined and before the virtual synchronization primitive is inserted into each instruction pair in S103, a control flow graph corresponding to the program needs to be further normalized, to ensure that the operation of inserting the additional virtual synchronization primitive described in S103 can be implemented. Normalizing the control flow graph includes normalizing a loop structure and normalizing a branch structure. Normalizing the loop structure mainly includes adding a preheader and an exit block to the loop structure. Normalizing the branch structure means adding a sibling node to a basic block in the branch structure. The sibling node is a plurality of basic blocks that have no precursor or successor relationship and have a same dominant node and post-dominant node in the control flow graph.

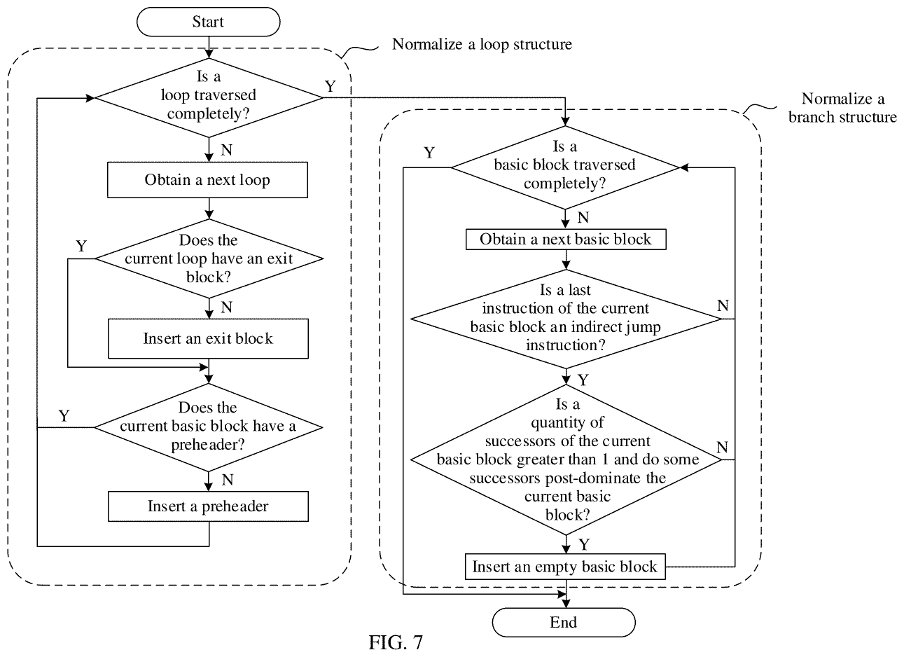

FIG. 7 is a schematic flowchart in which a control flow graph is normalized according to an embodiment of this application. When the loop structure is normalized, each loop is traversed. For any loop, it is first determined whether a current loop has an exit block. If the current loop does not have an exit block, an exit block is inserted into the current loop. After the exit block is inserted into the current loop or when the current loop has an exit block, it is determined whether the current loop has a preheader. If the current loop does not have a preheader, a preheader is inserted into the current loop. When the preheader is inserted into the current loop or when the current loop has a preheader, the same operations as those described above are performed on a next loop until each loop is traversed.

Optionally, a computing device may determine, through a getLoopPreheader interface provided by an LLVM, whether the loop has a preheader, and insert the preheader through InsertPreheaderForLoop( ), The computing device may determine, through a hasDedicatedExits interface provided by the LLVM, whether the loop has an exit block, and insert the exit block, for example, DedicatedExits through formDedicatedExitBlocks( ).

When the branch structure is normalized, for any basic block, for example, a first basic block, it is first determined whether a last instruction of the first basic block is an indirect jump instruction. If the last instruction of the first basic block is an indirect jump instruction, it is then determined whether a quantity of successors of the first basic block is greater than 1; and if the quantity of successors of the first basic block is greater than 1 and a second basic block that is a successor post-dominates the first basic block, a corresponding empty basic block, for example, a third basic block, needs to be added between the second basic block and the first basic block. If the last instruction of the first basic block is not an indirect jump instruction, or the quantity of successors of the first basic block is 1, or no successor of the first basic block post-dominates a current basic block, a next basic block is obtained, and the same operations as those described above are performed until each basic block is traversed. It should be understood that, when an empty basic block is inserted, it needs to be ensured that an original sequence relationship between basic blocks in the control flow graph remains unchanged.

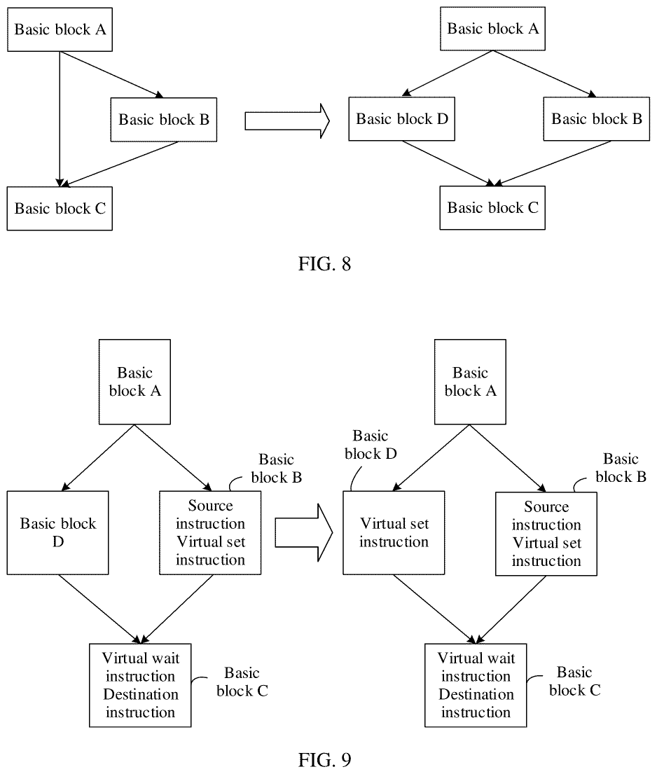

FIG. 8 is a diagram in which a branch structure is normalized according to an embodiment of this application. In FIG. 8, a basic block A is a precursor of a basic block B and a basic block C, and the basic block B is also a precursor of the basic block C; in other words, the basic block B and the basic block C are successors of the basic block A, and the basic block Cis a successor of the basic block B. The current basic block A has two successors, and the basic block C post-dominates the basic block A. If the last instruction of the current basic block A is an indirect jump instruction, an empty basic block D is inserted between the basic block A and the basic block C. In this case, the basic block D and the basic block B are sibling nodes. After the basic block D is inserted, the successor C corresponding to the basic block A needs to be replaced with D, and the basic block A in an input basic block of a PHI node of the basic block C needs to be replaced with the basic block D.

In a possible implementation, in the foregoing S103, after the virtual synchronization primitive is inserted into each of the instruction pairs, the virtual synchronization primitive needs to be further improved, and an additional virtual set instruction or virtual wait instruction is inserted into the program, to ensure that virtual set instructions and virtual wait instructions on all execution paths are in pairs when the program is executed, thereby ensuring that the program can be executed normally.

For example, FIG. 9 is a diagram in which a virtual synchronization primitive is improved according to an embodiment of this application. In the normalized branch structure shown in FIG. 8, if an instruction pair exists in the basic block B and the basic block C, according to the method in (1) in S103, a virtual set instruction is inserted after a source instruction in the basic block B, and a virtual wait instruction is inserted before a destination instruction of the basic block C. In an execution process of the program, if an execution path of the basic block A->the basic block B->the basic block C is used, the program can be executed normally. If an execution path of the basic block A->the basic block D->the basic block C is used in an execution process, because the basic block D is an empty basic block, in the execution process of the program, a virtual wait instruction in the basic block C is executed after an instruction in the basic block A is finished, but a virtual set instruction corresponding to the virtual wait instruction is not executed. Consequently, a flag bit corresponding to a virtual ID in the virtual wait instruction is not set, and the program is blocked and cannot continue to be executed. In this case, a virtual set instruction that is the same as that in the basic block B needs to be inserted into the basic block D to ensure that the program can be executed normally.

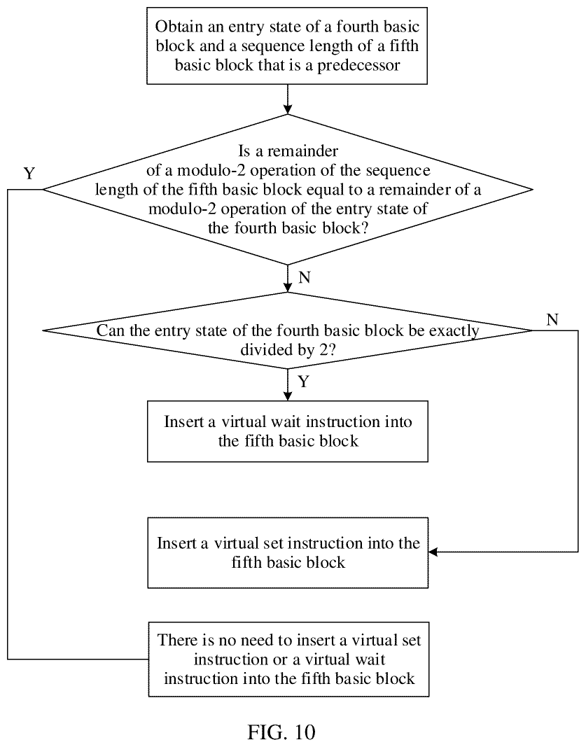

FIG. 10 is a schematic flowchart in which a virtual synchronization primitive is improved according to an embodiment of this application. When a virtual synchronization primitive is improved and an additional virtual set instruction or virtual wait instruction is inserted, each basic block is traversed. For a current basic block, it needs to be determined, based on a sequence length of each precursor of the current basic block and an entry state of the current basic block, whether a virtual set instruction or a virtual wait instruction needs to be inserted into each precursor, and whether a virtual set instruction or a virtual wait instruction is inserted. When a virtual synchronization primitive corresponding to a first pipeline pair is improved, a sequence length of a precursor is a quantity of virtual set instructions and virtual wait instructions in the precursor that are executed by a first pipeline pair; to be specific, when a virtual synchronization primitive corresponding to the first pipeline pair is improved, the sequence length of the precursor is a quantity of virtual set primitives and virtual wait instructions whose source pipeline is a pipeline 1 and destination pipeline is a pipeline 2; and the entry state of the current basic block is a value with a maximum sequence length among all precursors of the current basic block.

For the current basic block, for example, a fourth basic block, if the fourth basic block has a plurality of precursors, an entry state of the fourth basic block and sequence lengths of the precursors are first obtained. Then, for any one of the precursors, for example, a fifth basic block, if a remainder of a modulo-2 operation of a sequence length of the fifth basic block is equal to a remainder of a modulo-2 operation of the entry state of the fourth basic block, it is determined that no virtual set instruction or virtual wait instruction needs to be inserted into the fifth basic block; or if a remainder of a modulo-2 operation of a sequence length of the fifth basic block is not equal to a remainder of a modulo-2 operation of the entry state of the fourth basic block, it is determined that a virtual set instruction or a virtual wait instruction needs to be inserted into the fifth basic block, where specifically, if the entry state of the fourth basic block cannot be exactly divided by 2, a virtual set instruction needs to be inserted into the fifth basic block, and a virtual ID in the virtual set instruction is the same as a virtual ID in a first virtual wait instruction in the fourth basic block; or if the entry state of the fourth basic block can be exactly divided by 2, a virtual wait instruction needs to be inserted into the fifth basic block, and a virtual ID in the virtual wait instruction is the same as a virtual ID in a virtual set instruction before the virtual wait instruction.

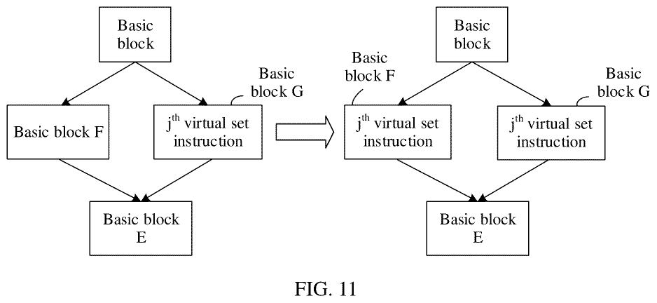

For example, FIG. 11 is another diagram in which a virtual synchronization primitive is improved according to an embodiment of this application. In FIG. 11, for a current basic block E, the basic block E has two precursors: a basic block F and a basic block G. If no virtual synchronization primitive exists in the basic block F, a sequence length of the basic block F1 is 0; or if there is only one j^{th} virtual set instruction in the basic block G, a sequence length of the basic block G is 1. An entry state of the current basic block E is 1.

For the basic block F, if a remainder of a modulo-2 operation of a sequence length 0 of the basic block F is 0, which is not equal to a remainder of a modulo-2 operation of the entry state 1 of the current basic block E, it is determined that a virtual set instruction or a virtual wait instruction needs to be inserted into the basic block F. Because the entry state 1 of the current basic block E cannot be exactly divided by 2, a virtual set instruction needs to be inserted into the basic block F, where a virtual ID in the virtual set instruction is the same as a virtual ID in a virtual set instruction in the basic block G.

In a possible implementation, after the virtual synchronization primitive is inserted into the program according to S103 and the method shown in FIG. 10, redundancy removal needs to be further performed on the inserted virtual synchronization primitive.

During redundancy removal from an inserted virtual synchronization primitive, when redundancy removal is performed on a virtual synchronization primitive inserted into a first pipeline pair, all combinations of virtual IDs are traversed, and redundancy removal is performed on virtual synchronization primitives based on a dominance relationship and/or a post-dominance relationship between virtual synchronization primitives corresponding to different virtual IDs. If virtual IDs of virtual synchronization primitives inserted into a pipeline pair are 1 to n, a quantity of combinations of virtual IDs is n(n−1). For example, if the virtual IDs are 1 to 3, combinations of the virtual IDs include (1,2), (1,3), (2,1), (2,3), (3,1), and (3,2).

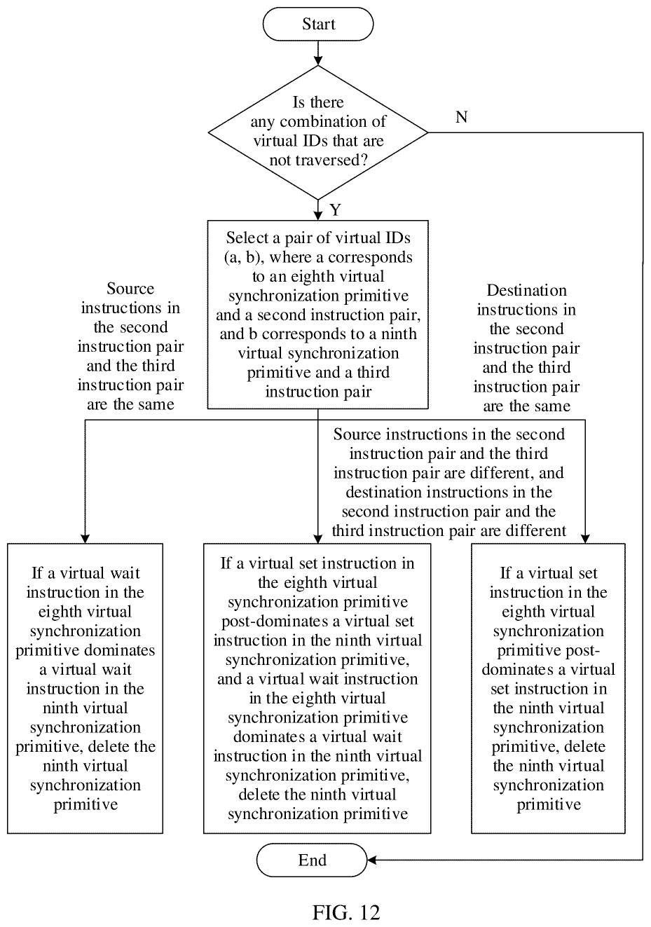

FIG. 12 is a schematic flowchart in which redundancy removal is performed on a virtual synchronization primitive according to an embodiment of this application. When redundancy removal is performed on virtual synchronization primitives based on a dominance relationship and/or a post-dominance relationship between virtual synchronization primitives corresponding to different virtual IDs, for any combination (a, b) of the virtual IDs, redundancy removal needs to be performed in the following three cases, where a and b are not the same.

(1) Source instructions in instruction pairs corresponding to two virtual synchronization primitives are the same.

If a virtual synchronization primitive whose virtual ID is a is an eighth virtual synchronization primitive, and a virtual synchronization primitive whose virtual ID is b is a ninth virtual synchronization primitive, when a source instruction in a second instruction pair corresponding to the eighth virtual synchronization primitive is the same as a source instruction in a third instruction pair corresponding to the ninth virtual synchronization primitive, and a virtual wait instruction in the eighth virtual synchronization primitive dominates a virtual wait instruction in the ninth virtual synchronization primitive, the ninth virtual synchronization primitive whose virtual ID is b is deleted. That the virtual wait instruction in the eighth virtual synchronization primitive dominates the virtual wait instruction in the ninth virtual synchronization primitive means that virtual wait instructions whose virtual IDs are a exist on paths from the source instruction in the second instruction pair to all virtual wait instructions whose virtual IDs are b.

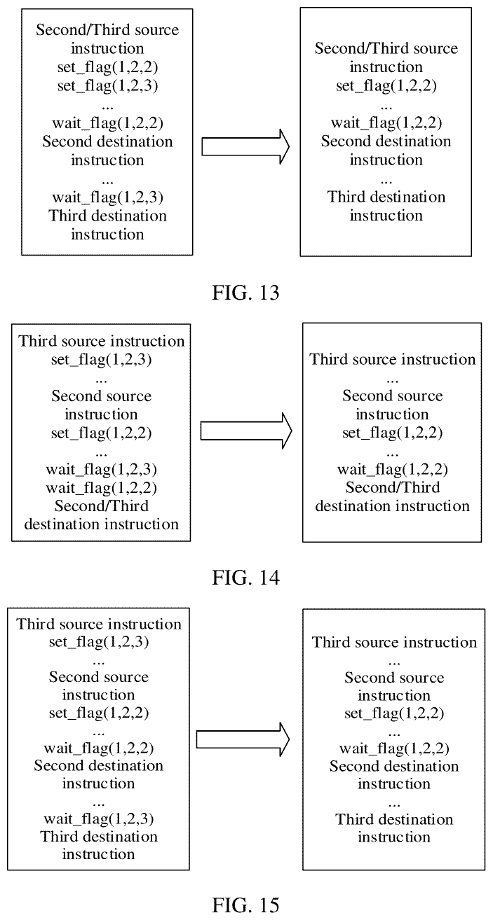

FIG. 13 is a diagram in which redundancy removal is performed on a virtual synchronization primitive according to an embodiment of this application. In FIG. 13, there are two instruction pairs: a second instruction pair and a third instruction pair. The second instruction pair includes a second source instruction and a second destination instruction, and the third instruction pair includes a third source instruction and a third destination instruction. The second source instruction is the same as the third source instruction. When a virtual synchronization primitive is inserted, set_flag(1,2,2) is inserted after the second source instruction, wait_flag(1,2,2) is inserted before the second destination instruction, set_flag(1,2,3) is inserted after the third source instruction, and wait_flag(1,2,3) is inserted before the third destination instruction. In an execution process of the program, starting from the second source instruction, wait_flag(1,2,2) is definitely executed first, and then wait_flag(1,2,3) is executed. In this case, wait_flag(1,2,2) dominates wait_flag(1,2,3). In addition, because the second source instruction is the same as the third source instruction, when the program is executed, an execution sequence is as follows: the second/third source instruction, set_flag(1,2,2), set_flag(1,2,3), wait_flag(1,2,2), the second destination instruction, wait_flag(1,2,3), and the third destination instruction. When wait_flag(1,2,3) and the third destination instruction are executed, wait_flag(1,2,2) and the second destination instruction are definitely finished, indicating that the second source instruction/third source instruction is definitely finished. In view of this, set_flag(1,2,3) and wait_flag(1,2,3) may not be executed before the third destination instruction is executed; and a virtual synchronization primitive corresponding to the third instruction pair may be deleted.

(2) Destination instructions in instruction pairs corresponding to two virtual synchronization primitives are the same.

If a virtual synchronization primitive whose virtual ID is a is an eighth virtual synchronization primitive, and a virtual synchronization primitive whose virtual ID is b is a ninth virtual synchronization primitive, when a destination instruction in a second instruction pair corresponding to the eighth virtual synchronization primitive is the same as a destination instruction in a third instruction pair corresponding to the ninth virtual synchronization primitive, and a virtual set instruction in the eighth virtual synchronization primitive post-dominates a virtual set instruction in the ninth virtual synchronization primitive, the ninth virtual synchronization primitive whose virtual ID is b is deleted. That the virtual set instruction in the eighth virtual synchronization primitive post-dominates the virtual set instruction in the ninth virtual synchronization primitive means that virtual set instructions whose virtual IDs are a exist on paths from a source instruction in the third instruction pair to the destination instruction in the third instruction.

For example, FIG. 14 is another diagram in which redundancy removal is performed on a virtual synchronization primitive according to an embodiment of this application. In FIG. 14, there are two instruction pairs: a second instruction pair and a third instruction pair. The second instruction pair includes a second source instruction and a second destination instruction, and the third instruction pair includes a third source instruction and a third destination instruction. The second destination instruction is the same as the third destination instruction. When a virtual synchronization primitive is inserted, set_flag(1,2,2) is inserted after the second source instruction, wait_flag(1,2,2) is inserted before the second destination instruction, set_flag(1,2,3) is inserted after the third source instruction, and wait_flag(1,2,3) is inserted before the third destination instruction. In an execution process of the program, starting from the third source instruction, set_flag(1,2,3) is executed first, and then the second source instruction and set_flag(1,2,2) are executed. In this case, set_flag(1,2,2) post-dominates set_flag(1,2,3). In addition, because the second destination instruction is the same as the third destination instruction, when the program is executed, an execution sequence is as follows: the third source instruction, set_flag(1,2,3), the second source instruction, set_flag(1,2,2), wait_flag(1,2,3), wait_flag(1,2,2), and the second/third destination instruction. When wait_flag(1,2,3) and the third destination instruction are executed, set_flag(1,2,2) and the second source instruction are definitely finished, indicating that the third source instruction is definitely finished. In view of this, set_flag(1,2,3) and wait_flag(1,2,3) may not be executed after the third source instruction is executed; and a virtual synchronization primitive corresponding to the third instruction pair may be deleted.

(3) Source instructions in instruction pairs corresponding to two virtual synchronization primitives are different and destination instructions in the instruction pairs corresponding to the two virtual synchronization primitives are different.

If a virtual synchronization primitive whose virtual ID is a is an eighth virtual synchronization primitive, and a virtual synchronization primitive whose virtual ID is b is a ninth virtual synchronization primitive, when a source instruction and a destination instruction in a second instruction pair corresponding to the eighth virtual synchronization primitive are respectively different from a source instruction and a destination instruction in a third instruction pair corresponding to the ninth virtual synchronization primitive, a virtual set instruction in the eighth virtual synchronization primitive post-dominates a virtual set instruction in the ninth virtual synchronization primitive, and a virtual wait instruction in the eighth virtual synchronization primitive dominates a virtual wait instruction in the ninth virtual synchronization primitive, the ninth virtual synchronization primitive whose virtual ID is b is deleted.

FIG. 15 is still another diagram in which redundancy removal is performed on a virtual synchronization primitive according to an embodiment of this application. In FIG. 15, there are two instruction pairs: a second instruction pair and a third instruction pair. The second instruction pair includes a second source instruction and a second destination instruction, and the third instruction pair includes a third source instruction and a third destination instruction. When a virtual synchronization primitive is inserted, set_flag(1,2,2) is inserted after the second source instruction, wait_flag(1,2,2) is inserted before the second destination instruction, set_flag(1,2,3) is inserted after the third source instruction, and wait_flag(1,2,3) is inserted before the third destination instruction. In an execution process of the program, starting from the third source instruction, set_flag(1,2,3) is executed first, and then the second source instruction and set_flag(1,2,2) are executed. In this case, set_flag(1,2,2) post-dominates set_flag(1,2,3). Then, wait_flag(1,2,2) is executed first, and then wait_flag(1,2,3) is executed. In this case, wait_flag(1,2,2) dominates wait_flag(1,2,3). When wait_flag(1,2,3) and the third destination instruction are executed, wait_flag(1,2,2) and the second destination instruction are definitely finished, indicating that the second source instruction is definitely finished, and correspondingly the third source instruction is definitely finished. In view of this, set_flag(1,2,3) and wait_flag(1,2,3) may not be executed before the third destination instruction is executed; and a virtual synchronization primitive corresponding to the third instruction pair may be deleted.

According to the foregoing method, combinations of different virtual IDs are traversed, and redundancy removal is performed on two virtual synchronization primitives that meet any one of the foregoing cases according to a corresponding method, so as to reduce a quantity of synchronization primitives in the program, avoid introducing excessive synchronization primitives, and improve program performance.

In embodiments of this application, according to S103 and the method shown in FIG. 10, after a virtual synchronization primitive is inserted into the program, and before an event ID corresponding to each virtual synchronization primitive is determined and a virtual ID in the virtual synchronization primitive is replaced with the event ID to obtain a synchronization primitive, it needs to be ensured that when the program is at any program point, in a virtual ID corresponding to the first pipeline pair, a quantity of currently active virtual IDs is less than or equal to N. The active virtual ID is a virtual ID in a virtual synchronization primitive corresponding to an instruction pair that is in the first pipeline pair and that is not finished when the program runs to the current program point. N is a quantity of flag bits of the first pipeline pair, namely, a quantity of event IDs corresponding to the first pipeline pair.

In a possible implementation, according to S103 and the method shown in FIG. 10, after a virtual synchronization primitive is inserted into the program or redundancy removal is performed on an inserted virtual synchronization primitive, it needs to be determined whether a quantity of simultaneously active virtual IDs is greater than N at any program point, for example, a first program point. If a quantity of currently active virtual IDs is greater than N, virtual synchronization primitives corresponding to the currently active virtual IDs may be merged, so that at any program point, in a virtual ID corresponding to the first pipeline pair, a quantity of active virtual IDs is less than or equal to N.

When the virtual synchronization primitives corresponding to the active virtual IDs are merged, the virtual synchronization primitives corresponding to the active virtual IDs include two virtual synchronization primitives (a fourth virtual synchronization primitive and a fifth virtual synchronization primitive) that meet the following conditions: A source instruction and a destination instruction in a fourth instruction pair corresponding to the fourth virtual synchronization primitive that uses a second virtual ID are cross-iteration instructions, and a source instruction and a destination instruction in a fifth instruction pair corresponding to the fifth virtual synchronization primitive that uses a third virtual ID are cross-iteration instructions; and a virtual set instruction in an additional fourth virtual synchronization primitive corresponding to the fourth instruction pair and a virtual set instruction in an additional fifth virtual synchronization primitive corresponding to the fifth instruction pair are located on a preheader of a same loop, and a virtual wait instruction in the additional fourth virtual synchronization primitive corresponding to the fourth instruction pair and a virtual wait instruction in the additional fifth virtual synchronization primitive corresponding to the fifth instruction pair are located on an exit block of the same loop. In this case, when the virtual wait instruction in the fourth virtual synchronization primitive dominates the virtual wait instruction in the fifth virtual synchronization primitive, and the virtual set instruction in the fifth virtual synchronization primitive post-dominates the virtual set instruction in the fourth virtual synchronization primitive, the virtual set instruction in the fourth virtual synchronization primitive and the virtual wait instruction in the fifth virtual synchronization primitive may be deleted, the additional fifth virtual synchronization primitives corresponding to the fifth instruction pairs in the preheader and the exit block may be deleted, and the third virtual ID in the virtual set instruction in the fifth virtual synchronization primitive is replaced with the second virtual ID in the fourth synchronization primitive.

If the virtual synchronization primitives corresponding to the currently active virtual IDs do not include a virtual synchronization primitive that meets the foregoing relationship, two active virtual IDs are randomly selected from the currently active virtual IDs, and instruction pairs corresponding to virtual synchronization primitives that use the two virtual IDs are non-cross-iteration instruction pairs. For example, if a fourth instruction pair corresponding to a fourth virtual synchronization primitive that uses a second virtual ID is not a cross-iteration instruction pair, and a fifth instruction pair corresponding to a fifth virtual synchronization primitive that uses a third virtual ID is not a cross-iteration instruction pair either, the second virtual ID and the third virtual ID are selected. In this case, a target virtual set instruction and a target virtual wait instruction may be determined in the fourth virtual synchronization primitive and/or the fifth virtual synchronization primitive, a virtual ID in the target virtual set instruction and the target virtual wait instruction is replaced with the second virtual ID, and virtual synchronization primitives that use the second virtual ID and the third virtual ID other than the target virtual set instruction and the target virtual wait instruction are deleted. The target virtual set instruction is a 2^{nd} virtual set instruction that uses the second virtual ID or the third virtual ID and that is encountered in a process of traversing the program. The target virtual wait instruction is a 1^{st} virtual wait instruction that uses the second virtual ID or the third virtual ID and that is encountered in the process of traversing the program.

The following describes how to determine the target virtual set instruction and the target virtual wait instruction.

In embodiments of this application, for example, the second virtual ID is c, and the third virtual ID is d. In a process of performing the foregoing merging operation, two data structures setInstsInfo and setWaitInstsNum need to be set. setInstsInfo is used to store each set_flag(1,2,c/d) encountered in a traversal process, that is, store virtual set instructions that are encountered in the traversal process and executed by the first pipeline pair and whose virtual IDs are c and d. For example, setInstsInfo [A]={set_flag(1,2,c);set_flag(1,2,d)} indicates that two virtual set instructions that use c and d exist from a program entry to a time point when the basic block A is traversed completely. setWaitInstsNum is used to store a quantity of set_flag/wait_flag(1,2,c/d) encountered in the traversal process, that is, store a quantity of virtual instructions that are encountered in the traversal process and executed by the first pipeline pair and whose virtual IDs are c and d. The virtual instructions include a virtual set instruction and a virtual wait instruction. For example, setWaitInstsNum [A]=3 indicates that three virtual instructions that use c and d exist from the program entry to the time point when the basic block A is traversed completely.

It should be noted that, because one basic block includes a plurality of instructions, values of setInstsInfo and setWaitInstsNum change in a process of traversing one basic block. In embodiments of this application, unless otherwise specified, both setInstsInfo and setWaitInstsNum are values obtained after one basic block is traversed completely. For example, setInstsInfo[E] is a value obtained after instructions in the basic block E are traversed completely.

In a process of traversing basic blocks of the program, for any basic block in the traversal process, for example, the basic block E, values of setInstsInfo[E] and setWaitInstsNum[E] corresponding to an entry of the basic block E are first determined.

Specifically, if a traversed instruction is a first instruction in the current basic block E, the values of setInstsInfo[E] and setWaitInstsNum[E] corresponding to the entry of the basic block E are determined based on values of setInstsInfo and setWaitInstsNum corresponding to one or more precursors of the basic block E.

If the basic block E has only one precursor, a value of setInstsInfo[E] corresponding to the entry of the basic block E is set to a value of setInstsInfo corresponding to the precursor of the basic block E, and a value of setWaitInstsNum[E] corresponding to the entry of the basic block E is set to a value of setWaitInstsNum corresponding to the precursor.

If the basic block E corresponds to a plurality of precursors, the values of setInstsInfo[E] and setWaitInstsNum[E] corresponding to the entry of the basic block E need to be determined based on values of setInstsInfo and setWaitInstsNum in the plurality of precursors. For example, the basic block E corresponds to two precursors: the basic block F and the basic block G. When the entry of the basic block E is traversed for the first time through a path where one of the precursors is located, for example, when the entry of the basic block E is traversed through the basic block F, neither setInstsInfo[E] nor setWaitInstsNum[E] has a value. In this case, setInstsInfo[E] corresponding to the entry of the basic block E is set to setInstsInfo[F], and setWaitInstsNum[E] corresponding to the entry of the basic block E is set to set WaitInstsNum[F].

Then, when the entry of the basic block E is traversed through a path where another precursor G is located, setInstsInfo[E] and setWaitInstsNum[E] corresponding to the entry of the basic block E have corresponding values. If setWaitInstsNum[E] corresponding to the entry of the basic block E is less than setWaitInstsNum[G], setInstsInfo[E] corresponding to the entry of the basic block E is set to setInstsInfo[G], and setWaitInstsNum[E] corresponding to the entry of the basic block E is set to setWaitInstsNum[G]. If setWaitInstsNum[E] corresponding to the entry of the basic block E is equal to setWaitInstsNum[G], setInstsInfo[E] and setInstsInfo[G] corresponding to the entry of the basic block E are merged, that is, setInstsInfo[F] and setInstsInfo[G] are merged, and a merged result is used as setInstsInfo[E] corresponding to the entry of the basic block E.

When the basic block E corresponds to a plurality of precursors, the precursors are traversed in sequence according to the foregoing description, to determine setInstsInfo[E] and set WaitInstsNum[E] corresponding to the entry of the basic block E.

After setInstsInfo[E] and setWaitInstsNum[E] corresponding to the entry of the basic block E are determined, instructions in the basic block E are sequentially traversed. For one to-be-processed instruction in the basic block E, it is first determined whether the to-be-processed instruction is a virtual set instruction or a virtual wait instruction that uses c or d, that is, whether the to-be-processed instruction is set_flag(1,2,c/d) or wait_flag(1,2,c/d). If the to-be-processed instruction is not the foregoing virtual set instruction or virtual wait instruction that uses c or d, a next instruction continues to be determined; or if the to-be-processed instruction is the virtual set instruction or virtual wait instruction that uses c or d, the following operations are performed.

(1) The to-be-processed instruction is a virtual set instruction, that is, the to-be-processed instruction is set_flag(1,2,c/d).

If setInstsInfo[E] is null when the to-be-processed instruction is traversed, it indicates that set_flag(1,2,c/d) is not encountered before the to-be-processed instruction, and the to-be-processed instruction is a 1^{st} set_flag(1,2,c/d) encountered in the traversal process. In this case, the to-be-processed instruction is recorded in setInstsInfo[E], and a value of setWaitInstsNum[E] is increased by 1. For example, if the to-be-processed instruction is set_flag(1,2,c). After the to-be-processed instruction is processed, setInstsInfo[E] is equal to {set_flag(1,2,c)}.

If setInstsInfo[E] is not null when the to-be-processed instruction is traversed, it indicates that a virtual set instruction that uses c or d has been encountered before, and the to-be-processed instruction is a 2^{nd} set_flag(1,2,c/d) in the traversal process. In this case, the to-be-processed instruction is a target virtual set instruction, a value of setWaitInstsNum[E] is increased by 1, and set_flag(1,2,c/d) that is previously encountered in the program is deleted.

(2) The to-be-processed instruction is a virtual wait instruction, that is, the to-be-processed instruction is wait_flag(1,2,c/d).

If setWaitInstsNum[E] is not equal to 0 and setInstsInfo[E] is not null when the to-be-processed instruction is traversed, it indicates that the to-be-processed instruction is a 1st wait_flag(1,2,c/d) currently encountered. In this case, the to-be-processed instruction is the target virtual wait instruction. In this case, a value of setWaitInstsNum[E] is increased by 1, and then setInstsInfo[E] is cleared.

If set WaitInstsNum[E] is not equal to 0 and setInstsInfo[E] is null when the to-be-processed instruction is traversed, it indicates that the to-be-processed instruction is a 2nd wait_flag(1,2,c/d) currently encountered. In this case, the to-be-processed instruction is deleted, and then a value of setWaitInstsNum[E] is increased by 1.

According to the foregoing method, locations of the target set instruction and the target virtual wait instruction can be determined, the virtual ID in the target set instruction and/or the target wait instruction is replaced with c, and the virtual reset instruction and the virtual wait instruction whose virtual ID is c or d other than the target set instruction and the target virtual wait instruction in the virtual synchronization primitive corresponding to the first pipeline pair is deleted.

According to the foregoing method, at any program point, if a quantity of currently active virtual IDs is greater than N, virtual synchronization primitives corresponding to currently active virtual IDs are merged according to the foregoing method, so as to ensure that a quantity of active virtual IDs is less than or equal to N when the program is at any program point. In the traversal process, the computing device may maintain a record vector for recording a currently active virtual ID.

It should be understood that the foregoing operation of merging virtual synchronization primitives when a quantity of simultaneously active virtual IDs are greater than N at a program point is to ensure that a quantity of active virtual IDs at any program point is less than or equal to a quantity of event IDs when the program is statically analyzed. After the virtual synchronization primitives are merged according to the foregoing method, in a process of replacing the virtual ID with the event ID according to the method in S105, a happen-before relationship between two synchronization primitives that use a same event ID in sequence is ensured, to ensure that when the program runs dynamically, a quantity of event IDs that are simultaneously active at any program point is less than or equal to N, that is, when the program is executed, two synchronization primitives do not need to use a same event ID.

It should be noted that, in the foregoing embodiment, the method for inserting a synchronization primitive provided in this application is described by using an example in which a synchronization primitive is inserted into an instruction pair executed by a pipeline pair. For an instruction pair executed by another pipeline pair, a corresponding synchronization primitive can be inserted with reference to an operation of the method. Details are not described herein again.

In embodiments of this application, for an instruction pair in which a source instruction and a destination instruction are executed by a same pipeline, only one synchronization primitive, for example, a barrier instruction, needs to be inserted after the source instruction and before the destination instruction in the instruction pair.

It should be noted that, for brief description, the foregoing method embodiments are all described as a combination of a series of actions. However, a person skilled in the art should understand that the present invention is not limited to the described action sequence. In addition, a person skilled in the art should also understand that all embodiments described in this specification are embodiments, and the related actions are not necessarily mandatory to the present invention.

Another appropriate step combination that can be figured out by a person skilled in the art based on the content described above also falls within the protection scope of the present invention.

The foregoing describes in detail the method for inserting a synchronization primitive provided in embodiments of this application with reference to the accompanying drawings. The following describes an apparatus, a chip, and a related device provided in embodiments of this application with reference to the accompanying drawings.

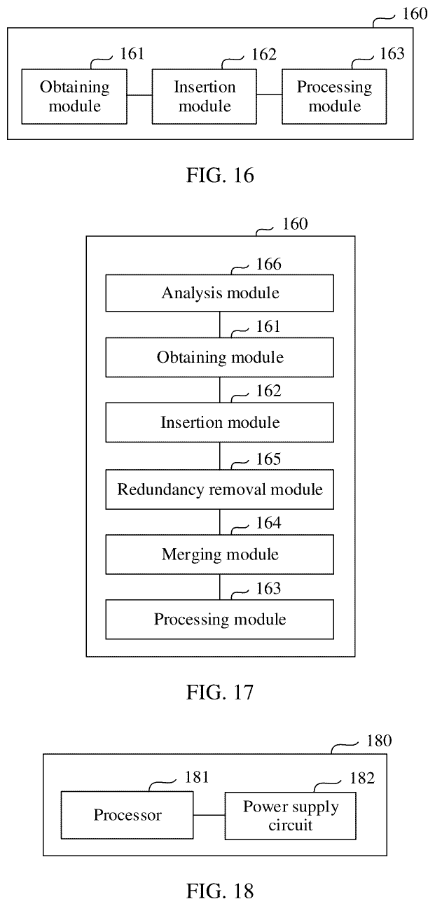

FIG. 16 is a diagram of an apparatus for inserting a synchronization instruction according to an embodiment of this application. The apparatus 160 includes an obtaining module 161, an insertion module 162, and a processing module 163. The obtaining module 161 is configured to obtain a plurality of instruction pairs in a program, where each instruction pair includes a source instruction and a destination instruction that have a dependency relationship, and the source instruction and the destination instruction in each instruction pair are executed by two different execution units.

The insertion module 162 is configured to insert a corresponding virtual synchronization primitive into each instruction pair. Specifically, for an operation that the insertion module 162 inserts the corresponding virtual synchronization primitive into each instruction pair, refer to the method described in S103 in the foregoing method embodiment. Details are not described herein.

The processing module 163 is configured to determine, based on the virtual synchronization primitive corresponding to each instruction pair, a synchronization primitive corresponding to each instruction pair. After the virtual synchronization primitive is inserted into each instruction pair, in an actual execution process of the program, because an actual flag bit of an accelerator card cannot be queried based on a virtual ID, a virtual ID in the virtual synchronization primitive needs to be replaced with an event ID, to obtain a synchronization primitive that can be executed during actual running of the program. Specifically, for an operation that the processing module 163 determines, based on the virtual synchronization primitive corresponding to each instruction pair, the synchronization primitive corresponding to each instruction pair, refer to the method described in S105 in the foregoing method embodiment. Details are not described herein.

In a possible implementation, FIG. 17 is a diagram of another apparatus for inserting a synchronization instruction according to an embodiment of this application. The apparatus 160 further includes a merging module 164. The merging module is configured to: obtain a currently active virtual ID at a first program point; and when a quantity of active virtual IDs is greater than N, merge virtual synchronization primitives to which the active virtual IDs belong. After the virtual synchronization primitive is inserted into the program, and before an event ID corresponding to each virtual synchronization primitive is determined and the virtual ID in the virtual synchronization primitive is replaced with the event ID to obtain the synchronization primitive, it needs to be ensured that when the program is at any program point, in a virtual ID corresponding to a first pipeline pair, a quantity of currently active virtual IDs is less than or equal to N. Virtual synchronization primitives corresponding to currently active virtual IDs are merged, so that a quantity of active virtual IDs in virtual IDs corresponding to the first pipeline pair at any program point is less than or equal to N. Specifically, for an operation that the merging module 164 merges virtual synchronization primitives, refer to the method for merging virtual synchronization primitives in the foregoing method embodiment. Details are not described herein again.

In a possible implementation, the apparatus 160 further includes a redundancy removal module 165. The redundancy removal module 165 is configured to: perform, based on a dominance relationship and/or a post-dominance relationship between virtual synchronization primitives corresponding to different instruction pairs, redundancy removal on the virtual synchronization primitives corresponding to the instruction pairs, so as to reduce a quantity of synchronization primitives in the program, avoid introducing excessive synchronization primitives, and improve program performance. Source instructions in the different instruction pairs are executed by a same execution unit, and destination instructions in the different instruction pairs are executed by a same execution unit. During redundancy removal from an inserted virtual synchronization primitive, when redundancy removal is performed on a virtual synchronization primitive inserted into the first pipeline pair, all combinations of virtual IDs are traversed, and redundancy removal is performed on virtual synchronization primitives based on a dominance relationship and/or a post-dominance relationship between virtual synchronization primitives corresponding to different virtual IDs. Specifically, for an operation that the redundancy removal module 165 performs redundancy removal on the virtual synchronization primitive, refer to the method for performing redundancy removal on a virtual synchronization primitive in the foregoing method embodiment. Details are not described herein again.

In a possible implementation, the insertion module 162 is further configured to: when a virtual synchronization primitive is inserted into a first instruction pair, if the first instruction pair includes instructions that have a cross-iteration dependency relationship, insert a first virtual wait instruction after a first virtual set instruction and insert a first virtual set instruction before the first virtual wait instruction. For example, a first virtual set instruction is inserted into a preheader of a loop to which the first instruction pair belongs, and a first virtual wait instruction is inserted into an exit block of the loop to which the first instruction pair belongs. Specifically, for an operation that the insertion module 162 inserts the corresponding virtual synchronization primitive into the instruction pair, refer to the method described in S103 in the foregoing method embodiment.

In a possible implementation, the insertion module 162 is further configured to: when the virtual synchronization primitive is inserted into the first instruction pair, if a first source instruction and a first destination instruction in the first instruction pair are unreachable to each other, insert a first virtual wait instruction before the first virtual set instruction, and insert a first virtual set instruction after the first virtual wait instruction. For example, a first virtual wait instruction is inserted before a first virtual set instruction of a basic block to which the first virtual set instruction belongs, and a first virtual set instruction is inserted after a first virtual wait instruction of the basic block to which the first virtual wait instruction belongs. Specifically, for an operation that the insertion module 162 inserts the corresponding virtual synchronization primitive into each instruction pair, refer to the method described in S103 in the foregoing method embodiment.

In a possible implementation, the insertion module 162 is further configured to normalize a control flow graph corresponding to the program. In a process of traversing the control flow graph of the program, when a first loop has no preheader and exit block, a preheader and an exit block are added to the first loop, where the first loop is any loop in the program.

In a possible implementation, the insertion module 162 is further configured to: when a last instruction in a first basic block is an indirect jump instruction, a quantity of successors of the first basic block is greater than 1, a second basic block is a successor of the first basic block, and the second basic block post-dominates the first basic block, add a third basic block between the first basic block and the second basic block, replace, with the third basic block, the second basic block in the successors of the first basic block in the control flow graph corresponding to the program, and replace a first basic block in input basic blocks of a PHI node of the second basic block with the third basic block. Specifically, for an operation that the insertion module 162 normalizes the control flow graph corresponding to the program, refer to the method for normalizing a control flow graph in the foregoing method embodiment. Details are not described herein again.

In a possible implementation, the insertion module 162 is further configured to: improve an inserted virtual synchronization primitive, and insert an additional virtual set instruction or virtual wait instruction into the program, to ensure that virtual set instructions and virtual wait instructions on all execution paths are in pairs when the program is executed, thereby ensuring that the program can be executed normally. Specifically, for an operation that the insertion module 162 improves the virtual synchronization primitive, refer to the method for completing the virtual synchronization primitive in the foregoing method embodiment. Details are not described herein again.

In a possible implementation, the apparatus 160 further includes an analysis module 166, configured to perform read-after-write analysis, write-after-read analysis, and write-after-write analysis on the program, to determine a plurality of instruction pairs that have a dependency relationship in the program. Specifically, for an operation that the analysis module 166 determines instructions that have a dependency relationship, refer to the method in S101 in the foregoing method embodiment. Details are not described herein again.

This application further provides an accelerator card. FIG. 18 is a diagram of an accelerator card according to an embodiment of this application. The accelerator card 180 includes a processor 181 and a power supply circuit 182. The power supply circuit 182 is configured to supply power to the accelerator card 180. The processor 181 is configured to implement the method for inserting a synchronization primitive into a program described in the foregoing method embodiments.

In embodiments of this application, the accelerator card may be any one of a graphics processing unit (GPU), an embedded neural-network processing unit (NPU), a tensor processing unit (TPU), a data processing unit (DPU), an accelerated processing unit (APU), a floating processing unit (FPU), an application-specific integrated circuit (ASIC), a programmable logic device (PLD), a field-programmable gate array (FPGA), or the like. This is not specifically limited in embodiments of this application.

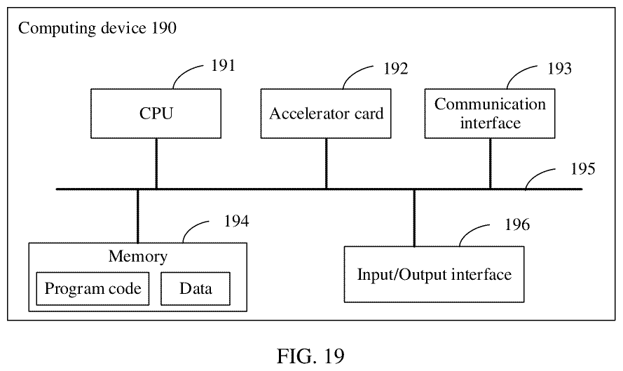

This application further provides a computing device. FIG. 19 is a diagram of a computing device according to an embodiment of this application. The computing device 190 includes: one or more central processing units (CPU) 191, one or more accelerator cards 192, a communication interface 193, and a memory 194. The one or more central processing units 191, the one or more accelerator cards 192, the communication interface 193, and the memory 194 are connected to each other through a bus 195.

There may be a plurality of types of accelerator cards 192. For example, the accelerator card 192 may be any one of chips such as a GPU, an NPU, a TPU, a DPU, an APU, an FPU, an ASIC, a PLD, or an FPGA. The computing device 190 may include one or more accelerator cards of any one of the foregoing types, or may include a plurality of types of accelerator cards. This is not specifically limited in embodiments of this application.

The central processing unit 191 or the accelerator card 192 may be configured to implement the operation of inserting the synchronization primitive into the program described in the foregoing method embodiment. For the method for implementing insertion of the synchronization primitive by the central processing unit 191 or the accelerator card 192, refer to descriptions in the foregoing method embodiment. Details are not described herein again.

The communication interface 193 may be a wired interface or a wireless interface, and is configured to communicate with another module or device. The wired interface may be an Ethernet interface, a local interconnect network (LIN), or the like. The wireless interface may be a cellular network interface, a wireless local area network interface, or the like. In embodiments of this application, the communication interface 193 may be specifically configured to perform an operation like obtaining code of an application that needs to be accelerated and that is uploaded by a user.

The memory 194 may be a nonvolatile memory, for example, a read-only memory (ROM), a programmable read-only memory (PROM), an erasable programmable read-only memory (EPROM), an electrically erasable programmable read-only memory (EEPROM), or a flash memory. Alternatively, the memory 194 may be a volatile memory. The volatile memory may be a random access memory (RAM) and is used as an external cache. By way of example, and not limitation, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

The memory 194 may also be configured to store program code and data, so that the central processing unit 191 or the accelerator card 192 invokes the program code stored in the memory 194 to perform the operation steps in the foregoing method embodiments. In addition, the computing device 190 may include more or fewer components than those shown in FIG. 19, or may have different component configurations.

The bus 195 may be a peripheral component interconnect (PCI) bus, an extended industry standard architecture (EISA) bus, or the like. The bus 195 may be classified into an address bus, a data bus, a control bus, and the like. For ease of representation, only one thick line is used for representing the bus in FIG. 19, but this does not mean that there is only one bus or only one type of bus.

Optionally, the computing device 190 may further include an input/output interface 196. The input/output interface 196 is connected to an input/output device, and is configured to: receive input information, and output an operation result, and the like.

Specifically, for a specific implementation in which the computing device 190 performs various operations, refer to specific operations in the foregoing method embodiments. Details are not described herein.

An embodiment of this application further provides a computer-readable storage medium. The computer-readable storage medium stores instructions. When the instructions are run on a processor, method steps in the foregoing method embodiments may be implemented. For a specific implementation in which the processor of the computer-readable storage medium performs the foregoing method steps, refer to specific operations in the foregoing method embodiments. Details are not described herein again.

In the foregoing embodiments, descriptions of each embodiment have respective focuses. For a part that is not described in detail in an embodiment, refer to related descriptions in other embodiments.

All or some of the foregoing embodiments may be implemented using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, all or some of the procedures or functions according to embodiments of the present invention are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk drive, or a magnetic tape), an optical medium, or a semiconductor medium. The semiconductor medium may be a solid state drive (SSD).

Steps in the methods in embodiments of this application may be sequentially scheduled, combined, or deleted according to an actual requirement. Modules in the apparatus in embodiments of this application may be divided, combined, or deleted according to an actual requirement.

Embodiments of this application are described in detail above. The principles and implementations of this application are described herein through specific examples. Descriptions about embodiments of this application are merely provided to help understand the method and core ideas of this application. In addition, a person of ordinary skill in the art can make variations and modifications in terms of the specific implementations and application scopes based on the ideas of this application. Therefore, the content of specification shall not be construed as a limit to this application.

1.-18. (canceled)

19. A method, comprising:
obtaining a plurality of instruction pairs in a program, wherein each instruction pair comprises a source instruction and a destination instruction that have a dependency relationship, and the source instruction and the destination instruction in each instruction pair are executed by two different execution units;
inserting a first virtual synchronization primitive into a first instruction pair, wherein the first virtual synchronization primitive comprises a first virtual identity (ID), and the first instruction pair is any of the plurality of instruction pairs; and
determining, based on the first virtual synchronization primitive, a first synchronization primitive corresponding to the first instruction pair, wherein the first synchronization primitive comprises a first event ID, wherein a quantity of event IDs corresponding to two execution units that execute the first instruction pair is a preset fixed value, and a quantity of virtual IDs corresponding to the two execution units that execute the first instruction pair is greater than the quantity of the event IDs.

20. The method according to claim 19, wherein:
the first virtual synchronization primitive comprises a first virtual set instruction and a first virtual wait instruction, and the first virtual set instruction and the first virtual wait instruction each comprise the first virtual ID;
the first synchronization primitive comprises a first set instruction and a first wait instruction, the first set instruction and the first wait instruction each comprise the first event ID, and the first synchronization primitive is obtained by replacing the first virtual ID in the first virtual synchronization primitive with the first event ID; and
the first set instruction is executed after a source instruction in the first instruction pair is executed, a flag bit corresponding to the first event ID is set, the first wait instruction is used to determine, when being executed, whether the flag bit corresponding to the first event ID is set, and when the flag bit corresponding to the first event ID is set, a destination instruction in the first instruction pair is executed.

21. The method according to claim 20, wherein determining, based on the first virtual synchronization primitive, the first synchronization primitive corresponding to the first instruction pair comprises:
determining a second synchronization primitive that uses the first event ID a last time, wherein a second set instruction in the second synchronization primitive and the first set instruction in the first synchronization primitive are executed by a same execution unit, and a second wait instruction in the second synchronization primitive and the first wait instruction in the first synchronization primitive are executed by a same execution unit; and
when a happen-before relationship exists between the second synchronization primitive and the first virtual synchronization primitive, replacing the first virtual ID in the first virtual synchronization primitive with the first event ID, to obtain the first synchronization primitive.

22. The method according to claim 20, wherein determining the first synchronization primitive based on the first virtual synchronization primitive comprises:
determining a second synchronization primitive that uses the first event ID a last time, wherein a second set instruction in the second synchronization primitive and the first set instruction in the first synchronization primitive are executed by a same execution unit, and a second wait instruction in the second synchronization primitive and the first wait instruction in the first synchronization primitive are executed by a same execution unit; and
when the second synchronization primitive and the first virtual synchronization primitive are unreachable to each other, replacing the first virtual ID in the first virtual synchronization primitive with the first event ID, to obtain the first synchronization primitive.

23. The method according to claim 20, wherein determining the first synchronization primitive based on the first virtual synchronization primitive comprises:
determining a second synchronization primitive that uses the first event ID a last time, wherein a second set instruction in the second synchronization primitive and the first set instruction in the first synchronization primitive are executed by a same execution unit, and a second wait instruction in the second synchronization primitive and the first wait instruction in the first synchronization primitive are executed by a same execution unit; and
when a no happen-before relationship or an unreachable relationship exists between the second synchronization primitive and the first virtual synchronization primitive, after a third virtual synchronization primitive is inserted between the second synchronization primitive and the first virtual synchronization primitive, replacing the first virtual ID in the first virtual synchronization primitive with the first event ID, to obtain the first synchronization primitive; and
wherein the third virtual synchronization primitive comprises a third virtual set instruction and a third virtual wait instruction, the third virtual set instruction is inserted after the second wait instruction in the second synchronization primitive, and the third virtual wait instruction is inserted before a first virtual set instruction in the first virtual synchronization primitive.

24. The method according to claim 20, further comprising:
before determining, based on the first virtual synchronization primitive, the first synchronization primitive corresponding to the first instruction pair, obtaining a currently active virtual ID at a first program point; and
when a quantity of active virtual IDs is greater than N, merging virtual synchronization primitives to which the active virtual IDs belong; and
wherein N is a quantity of event IDs between two execution units, each active virtual ID is a virtual ID in a virtual synchronization primitive corresponding to an unfinished instruction pair when the program is executed to the first program point, virtual set instructions in the virtual synchronization primitives to which the active virtual IDs belong are executed by a same execution unit, and virtual wait instructions in the virtual synchronization primitives to which the active virtual IDs belong are executed by a same execution unit.

25. The method according to claim 24, wherein merging the virtual synchronization primitives to which the active virtual IDs belong comprises:
when a source instruction and a destination instruction in an instruction pair corresponding to a fourth virtual synchronization primitive that uses a second virtual ID are cross-iteration instructions, a source instruction and a destination instruction in an instruction pair corresponding to a fifth virtual synchronization primitive that uses a third virtual ID are cross-iteration instructions, a virtual wait instruction in the fourth virtual synchronization primitive dominates a virtual wait instruction in the fifth virtual synchronization primitive, and a virtual set instruction in the fifth virtual synchronization primitive post-dominates a virtual set instruction in the fourth virtual synchronization primitive, deleting the virtual set instruction in the fourth virtual synchronization primitive and the virtual wait instruction in the fifth virtual synchronization primitive, and replacing the third virtual ID in the virtual set instruction in the fifth virtual synchronization primitive with the second virtual ID in the fourth synchronization primitive, wherein the second virtual ID and the third virtual ID belong to the active virtual IDs.

26. The method according to claim 25, further comprising:
when neither the source instruction nor the destination instruction in the instruction pair corresponding to each of the fourth virtual synchronization primitive and the fifth virtual synchronization primitive is a cross-iteration instruction, retaining a target virtual set instruction and a target virtual wait instruction, replacing a virtual ID in the target virtual set instruction and the target virtual wait instruction with the second virtual ID, and deleting virtual synchronization primitives that use the second virtual ID and the third virtual ID other than the target virtual set instruction and the target virtual wait instruction; and
wherein the target virtual set instruction is a 2nd virtual set instruction that uses the second virtual ID or the third virtual ID and that is encountered in a process of traversing the program, and the target virtual wait instruction is a 1st virtual wait instruction that uses the second virtual ID or the third virtual ID and that is encountered in the process of traversing the program.

27. The method according to claim 20, further comprising:
before determining, based on the first virtual synchronization primitive, the first synchronization primitive corresponding to the first instruction pair, performing, based on a dominance relationship or a post-dominance relationship between virtual synchronization primitives corresponding to different instruction pairs, redundancy removal on the virtual synchronization primitives corresponding to the instruction pairs; and
wherein source instructions in the different instruction pairs are executed by a same execution unit, and destination instructions in the different instruction pairs are executed by a same execution unit.

28. The method according to claim 20, wherein inserting the first virtual synchronization primitive into the first instruction pair comprises:
inserting a first virtual set instruction after a first source instruction in the first instruction pair, and inserting a first virtual wait instruction before a first destination instruction in the first instruction pair.

29. The method according to claim 28, further comprising:
when the first instruction pair comprises cross-iteration instructions that have a dependency relationship, inserting a first virtual set instruction into a preheader of a loop to which the first instruction pair belongs, and inserting a first virtual wait instruction into an exit block of the loop to which the first instruction pair belongs; and
wherein the preheader is a precursor of a loop header loop header of a loop, the exit block is a basic block corresponding to the preheader, and all precursors of the exit block are in the loop.

30. The method according to claim 28, further comprising:
when the first source instruction and the first destination instruction in the first instruction pair are unreachable to each other, inserting a first virtual wait instruction before a first virtual set instruction corresponding to the first source instruction, and inserting a first virtual set instruction after a first virtual wait instruction corresponding to the first destination instruction.

31. The method according to claim 20, further comprising:
before inserting the first virtual synchronization primitive into the first instruction pair, when a first loop has no preheader and exit block, adding a preheader and an exit block to the first loop, wherein the first loop is any loop in the program, the preheader is a precursor of a loop header of a loop, the exit block is a basic block corresponding to the preheader, and all precursors of the exit block are in the loop.

32. The method according to claim 20, further comprising:
before inserting the first virtual synchronization primitive into the first instruction pair, when a last instruction in a first basic block is an indirect jump instruction, a quantity of successors of the first basic block is greater than 1, a second basic block is a successor of the first basic block, and the second basic block post-dominates the first basic block, adding a third basic block between the first basic block and the second basic block, replacing, with the third basic block, the second basic block in the successors of the first basic block in a control flow graph corresponding to the program, and replacing a first basic block in input basic blocks of a PHI node of the second basic block with the third basic block.

33. The method according to claim 31, further comprising:
after inserting the first virtual synchronization primitive into the first instruction pair, when a fourth basic block has a plurality of precursors, inserting a virtual set instruction or a virtual wait instruction into the plurality of precursors based on sequence lengths of the plurality of precursors, so that a virtual set instruction and a virtual wait instruction on any execution path of the program are in pairs, wherein a sequence length corresponding to each one precursor is a sum of a quantity of virtual set instructions and a quantity of virtual wait instructions that are in the respective precursor and for which a source pipeline and a destination pipeline are the same.

34. The method according to claim 20, further comprising:
performing read-after-write analysis, write-after-read analysis, and write-after-write analysis on the program, to determine a plurality of instruction pairs that have a dependency relationship in the program.

35. An accelerator card, comprising:
a processor and a power supply circuit, wherein the power supply circuit is configured to supply power to the accelerator card, and the processor is configured to:
obtain a plurality of instruction pairs in a program, wherein each instruction pair comprises a source instruction and a destination instruction that have a dependency relationship, and the source instruction and the destination instruction in each instruction pair are executed by two different execution units;
insert a first virtual synchronization primitive into a first instruction pair, wherein the first virtual synchronization primitive comprises a first virtual identity (ID), and the first instruction pair is any one of the plurality of instruction pairs; and
determine, based on the first virtual synchronization primitive, a first synchronization primitive corresponding to the first instruction pair, wherein the first synchronization primitive comprises a first event ID, a quantity of event IDs corresponding to two execution units that execute the first instruction pair is a preset fixed value, and a quantity of virtual IDs corresponding to the two execution units that execute the first instruction pair is greater than the quantity of the event IDs.

36. The accelerator card according to claim 35, wherein:
the first virtual synchronization primitive comprises a first virtual set instruction and a first virtual wait instruction, and the first virtual set instruction and the first virtual wait instruction each comprise the first virtual ID;
the first synchronization primitive comprises a first set instruction and a first wait instruction, the first set instruction and the first wait instruction each comprise the first event ID, and the first synchronization primitive is obtained by replacing the first virtual ID in the first virtual synchronization primitive with the first event ID; and
the first set instruction is executed after a source instruction in the first instruction pair is executed, a flag bit corresponding to the first event ID is set, the first wait instruction is used to determine, when being executed, whether the flag bit corresponding to the first event ID is set, and when the flag bit corresponding to the first event ID is set, a destination instruction in the first instruction pair is executed.

37. A computing device, comprising:
a central processing unit, an accelerator card, and memory, wherein the memory stores instructions, the central processing unit or the accelerator card is configured to execute the instructions to:
obtain a plurality of instruction pairs in a program, wherein each instruction pair comprises a source instruction and a destination instruction that have a dependency relationship, and the source instruction and the destination instruction in each instruction pair are executed by two different execution units;
insert a first virtual synchronization primitive into a first instruction pair, wherein the first virtual synchronization primitive comprises a first virtual identity (ID), and the first instruction pair is any one of the plurality of instruction pairs; and
determine, based on the first virtual synchronization primitive, a first synchronization primitive corresponding to the first instruction pair, wherein the first synchronization primitive comprises a first event ID, a quantity of event IDs corresponding to two execution units that execute the first instruction pair is a preset fixed value, and a quantity of virtual IDs corresponding to the two execution units that execute the first instruction pair is greater than the quantity of the event IDs.

38. The computing device according to claim 37, wherein:
the first virtual synchronization primitive comprises a first virtual set instruction and a first virtual wait instruction, and the first virtual set instruction and the first virtual wait instruction each comprise the first virtual ID;
the first synchronization primitive comprises a first set instruction and a first wait instruction, the first set instruction and the first wait instruction each comprise the first event ID, and the first synchronization primitive is obtained by replacing the first virtual ID in the first virtual synchronization primitive with the first event ID; and
the first set instruction is executed after a source instruction in the first instruction pair is executed, a flag bit corresponding to the first event ID is set, the first wait instruction is used to determine, when being executed, whether the flag bit corresponding to the first event ID is set, and when the flag bit corresponding to the first event ID is set, a destination instruction in the first instruction pair is executed.
